(19) United States
(12) Patent Application Publication
(10) Pub. No.: US 2017/0121197 A1
(43) Pub. Date: May 4, 2017

(54) Biological Phosphorus Removal from Wastewater

(71) Applicant: Novozymes A/S, Bagsvaerd (DK)

(72) Inventor: Vaibhav TALE, Ontario (CA)

(73) Assignee: NOVOZYMES A/S, Bagsvaerd (DK)

(21) Appl. No.: 15/314,275

(22) PCT Filed: Jun. 17, 2015
(86) PCT No.: PCT/US2015/036245

§ 371 Date: Nov. 28, 2016

Related U.S. Application Data
(60) Provisional application No. 62/013,100, filed on Jun. 17, 2014.

(51) Int. Cl. C02F 3/30; C02F 3/34

(52) U.S. Cl. CPC C02F 3/308; C02F 3/34; C02F 2101/105

(57) ABSTRACT

Methods and systems are provided for treating wastewater to reduce or remove phosphorus. Phosphorus accumulating organisms, and optionally, carbon source is added to the wastewater process stream to increase phosphorus removal. Treated wastewater is directed to an aerobic tank, which promotes phosphorus consumption by bacteria therein. The process stream can be directly dosed with exogenous phosphorus accumulating organisms in combination with carbon source, such as directly to an anaerobic tank, or indirectly through underflow or recycle from sludge dewatering. Compositions and augmented phosphorus accumulating organisms are also provided. Pre-treatment of phosphorus accumulating organisms with a carbon source is also described, as well as stable formulations.

### CROSS-REFERENCE TO RELATED APPLICATIONS

This application claim priority benefit of U.S. provisional application No. 62/013,100 filed 17 Jun. 2014, the contents of which are fully incorporated herein by reference.

### REFERENCE TO A SEQUENCE LISTING

This application contains a Sequence Listing in computer readable form, which is incorporated herein by reference.

### FIELD OF THE INVENTION

The present disclosure relates to phosphorus removal from wastewater. Wastewater process streams are contacted with phosphorus accumulating organisms in accordance with the present disclosure using methods disclosed herein to reduce or eliminate phosphorus from wastewater. Stable formulations of phosphorus accumulating organisms are also disclosed.

### BACKGROUND

Removing phosphorus from wastewater can be difficult and include a high-cost process that requires the addition of additives such as metal salt or carbon source to a wastewater treatment process. For example, a carbon source, such as glycerol, may be added to the process in an anaerobic tank to assist with phosphorous removal. However, due to very large volume of wastewater treated, extremely large amounts of carbon source must be added to effectively increase its concentration in the wastewater. Thus the addition of a carbon source to wastewater is demanding and significantly contributes to the expense of treating wastewater. Known treatment methods and formulations are also problematic in that they can be unstable. Further, it can be difficult to stabilize the biological phosphorus removal activity of a wastewater treatment plant or recover such a plant after an upset. Moreover, known carbon source applications do not efficiently target phosphorus accumulating organisms. Accordingly, there is a continuous need for wastewater treatment processes and formulations that are stable and/or reduce or eliminate the amount of carbon source or other additives in a wastewater treatment process.

### SUMMARY

The present disclosure relates to a method of treating wastewater by contacting a wastewater treatment process stream with phosphorus accumulating organisms alone, or in combination with carbon source. In embodiments, phosphorus accumulating organisms are pretreated with carbon source prior to application to a wastewater treatment process stream. In embodiments, the phosphorus accumulating organisms are characterized as exogenous.

In embodiments, the present disclosure provides a suitable process for treating wastewater to remove phosphorus, the process including: contacting a wastewater process stream with one or more phosphorus accumulating organisms in combination with one or more carbon sources to form a mixed liquor, wherein the one or more phosphorus accumulating organisms uptake phosphorus from the mixed liquor, and separating the one or more phosphorus accumulating organisms from the mixed liquor. In embodiments, the step of contacting includes: flowing the mixed liquor into one or more basins including bacteria operating under aerobic or anoxic conditions to initiate phosphorus uptake by the bacteria and/or one or more phosphorus accumulating organisms, and the step of separating includes separating the bacteria from the mixed liquor. In embodiments, the one or more basins are aerated or anoxic. In embodiments, the one or more phosphorus accumulating organism is Tetrasphaera elongata. In embodiments, the one or more carbon sources include industrial carbonaceous waste. In embodiments, the one or more carbon sources are selected from the group consisting of acetic acid, propionic acid, glycerol, glucose, molasses, high fructose corn syrup, industrial carbonaceous waste, methanol, and combinations of these. In embodiments, the one or more carbon sources are obtained from recycled sludge. In embodiments, the wastewater process stream is underflow. In embodiments, the wastewater process stream is an anaerobic basin. In embodiments, the wastewater process stream is an aerobic or anoxic basin. In embodiments, phosphorus uptake occurs in an aerobic or anoxic basin.

In embodiments, the present disclosure provides a suitable process for treating wastewater to remove phosphorus, the process including: contacting a wastewater process stream with one or more phosphorus accumulating organisms in combination with one or more carbon sources to form a mixed liquor; flowing the mixed liquor into one or more aerated or anoxic basins including bacteria operating under aerobic or anoxic condition to initiate phosphorus uptake by the bacteria and one or more phosphorus accumulating organisms; and separating the bacteria and one or more phosphorus accumulating organisms from the wastewater. In embodiments, the one or more phosphorus accumulating organism is Tetrasphaera elongata. In embodiments, the one or more carbon sources include industrial carbonaceous waste. In embodiments, the one or more carbon sources are selected from the group consisting of acetic acid, propionic acid, glycerol, glucose, molasses, high fructose corn syrup, industrial carbonaceous waste, methanol, and combinations of these. In embodiments, the one or more carbon sources are obtained from dewatered sludge recycle. In embodiments, the wastewater process stream is underflow. In embodiments, the wastewater process stream is the anaerobic basin. In embodiments, the wastewater process stream is the aerobic or anoxic basin. In embodiments, the phosphorus uptake occurs in an aerobic or anoxic basin. In embodiments, the concentration of carbon source in the mixed liquor is an amount of at least 3 mg/L carbon source per mg/L phosphorus to be removed. In embodiments, the one or more phosphorus accumulating organisms is added into the process stream in amount of at least one phosphorus accumulating organism is 1×10¹ to 1×10¹⁰ colony forming units per ml of process stream. In embodiments, the concentration of phosphorus accumulating organisms in the process stream is 1×10¹ to 1×10¹⁰ colony forming units per ml of process stream, wherein the process stream is the underflow or processed underflow.

In embodiments, the present disclosure provides a suitable process for treating wastewater to remove phosphorus, the process including: flowing wastewater influent stream in an anaerobic basin to form an anaerobic process stream; flowing the anaerobic process stream into an a aerobic basin to form an aerobic process stream; contacting the aerobic process stream process stream with one or more phosphorus accumulating organisms in combination with one or more carbon sources to form a mixed liquor; flowing the mixed liquor into a secondary clarifier to form activated sludge, sludge and effluent; wherein the phosphorus is in the sludge. In embodiments, the one or more phosphorus accumulating organism is Tetrasphaera elongata. In embodiments, the one or more carbon sources include industrial carbonaceous waste. In embodiments, the one or more carbon sources are selected from the group consisting of acetic acid, propionic acid, glycerol, glucose, molasses, high fructose corn syrup, industrial carbonaceous waste, methanol, and combinations of these. In embodiments, the one or more carbon sources are obtained from dewatered sludge recycle. In embodiments, the wastewater process stream is underflow.

In embodiments, the present disclosure provides a suitable process for treating wastewater to remove phosphorus, the process including: pretreating one or more phosphorus accumulating organisms with one or more carbon sources to form one or more pretreated phosphorus accumulating organisms with stored carbon; contacting pretreated phosphorus accumulating organisms having stored carbon with a wastewater process stream to form a liquor; flowing the liquor into an aerated tank operating under aerobic condition to initiate phosphorus uptake by the phosphorus accumulating organisms bacteria; and separating the phosphorus accumulating organisms bacteria from the wastewater. In embodiments, the one or more pretreated phosphorus accumulating organism is Tetrasphaera elongata. In embodiments, the one or more carbon sources include industrial carbonaceous waste. In embodiments, the one or more carbon sources are selected from the group consisting of acetic acid, propionic acid, glycerol, glucose, molasses, high fructose corn syrup, industrial carbonaceous waste, methanol, and combinations of these. In embodiments, the one or more carbon sources are obtained from dewatered sludge recycle. In embodiments, the wastewater process stream is underflow.

In embodiments, the present disclosure provides a suitable process for treating wastewater to remove phosphorus, the process including: pretreating one or more phosphorus accumulating organisms with underflow or processed underflow, such as water removed from sludge, to form pretreated phosphorus accumulating organisms; contacting pretreated phosphorus accumulating organisms with a wastewater process stream to form a liquor; flowing the liquor into an aerated basin including bacteria operating under aerobic condition to initiate phosphorus uptake by the bacteria and pretreated phosphorus accumulating organisms; and separating the bacteria from the wastewater.

In embodiments, the present disclosure provides a composition including one or more phosphorus accumulating organisms and one or more carbon sources. In embodiments, the one or more phosphorus accumulating organisms is Tetrasphaera elongata. In embodiments, the one or more carbon sources include industrial carbonaceous waste. In embodiments, the one or more carbon sources are selected from the group consisting of acetic acid, propionic acid, glycerol, glucose, molasses, high fructose corn syrup, industrial carbonaceous waste, methanol, and combinations of these. Suitable compositions in accordance with the present disclosure include non-liquid or solid formulations. One non-limiting example of a solid formulation includes freeze-dried phosphorus accumulating organisms pretreated with carbon source prior to application to freeze-drying process. One non-limiting example of a freeze dried formulation includes freeze-dried Tetrasphaera elongata pretreated with carbon source prior to application to freeze-drying process. In embodiments, the freeze-dried composition includes one or more carbohydrates.

In embodiments, the present disclosure provides a suitable system for treating wastewater to remove phosphorus, the system including: one or more settling basins that receives plant influent wastewater; one or more anaerobic basins that receive influent from the settling tanks; one or more aerobic basins that receive influent from the anaerobic tanks; one or more anaerobic digester basins that receive sludge; one or more dewatering devices that separate sludge and water; wherein the aerobic tank includes bacteria and/or phosphorus accumulating organisms operating under aerobic condition to initiate phosphorus uptake by the bacteria and/or phosphorus accumulating organisms when contacted with a mixed liquor including a mixture of one or more phosphorus accumulating organisms in combination with one or more carbon sources.

In embodiments, the present disclosure provides a suitable process for treating wastewater to remove phosphorus, the process including: contacting a wastewater process stream with one or more pretreated phosphorus accumulating organisms in combination with one or more carbon sources to form a mixed liquor; flowing the mixed liquor into one or more aerated or anoxic basins comprising bacteria operating under aerobic or anoxic condition to initiate phosphorus uptake by the bacteria; and separating the bacteria from the wastewater. In embodiments, pretreated phosphorus accumulating organisms include PAO's contacted with carbon source prior to contact with wastewater.

In embodiments, the present disclosure provides a suitable method of reducing carbon requirements for phosphorus removal including: contacting a wastewater process stream with one or more pretreated phosphorus accumulating organisms in combination with one or more carbon sources to form a mixed liquor; flowing the mixed liquor into one or more aerated or anoxic basins including bacteria operating under aerobic or anoxic condition to initiate phosphorus uptake by the bacteria and with one or more pretreated phosphorus accumulating organisms; and separating the bacteria from the wastewater. In embodiments, pretreated phosphorus accumulating organisms include PAO's contacted with sufficient amount of carbon source prior to contact with wastewater.

In embodiments, the present disclosure provides a suitable method of reducing carbon requirements for phosphorus removal including: contacting a wastewater process stream with one or more pretreated phosphorus accumulating organisms, such as Tetrasphaera elongata pretreated with carbon source prior to application to freeze-drying process. Suitable non-limiting carbon sources include acetic acid, propionic acid, glycerol, glucose, molasses, high fructose corn syrup, industrial carbonaceous waste and methanol. In embodiments, stable freeze-dried formulations are made which include PAO's in combination with carbohyrdrate.

### BRIEF DESCRIPTION OF THE DRAWINGS

FIG. 1 illustrates a schematic view of a wastewater treatment process in accordance with one embodiment of the present disclosure.

FIG. 2 illustrates a schematic view of a wastewater treatment process in accordance with an embodiment of the present disclosure different than FIG. 1.

FIG. 3 illustrates a schematic view of a wastewater treatment process in accordance with an embodiment of the present disclosure different than FIG. 1 and FIG. 2.

FIG. 4 illustrates a schematic view of enhanced biological phosphorus removal using phosphate accumulating organism and carbon source in one embodiment of the present disclosure.

These and other aspects of this disclosure will be evident upon reference to the following detailed description.

### DETAILED DESCRIPTION OF PREFERRED EMBODIMENTS

Microorganisms alone, or in combination with one or more carbon sources are used in accordance with the present disclosure to biologically remove phosphorus from wastewater. As there is an environmental need to reduce or eliminate phosphorus from wastewater, microorganisms of the present disclosure alone, or in combination with carbon sources in accordance with the present disclosure can be applied to wastewater treatment and wastewater treatment facilities to improve phosphorus removal. Further, the amount of carbon source added to wastewater may be reduced or eliminated using the microorganisms in accordance with the present disclosure.

Suitable microorganisms for use in accordance with the present disclosure include bacteria useful in wastewater treatment facilities. In embodiments, suitable microorganisms include phosphorus accumulating organisms or PAOs. Non-limiting examples of suitable phosphorus accumulating organisms include, but are not limited to Pseudomonas spp., Acinetobacter spp., Microlunatus phosphovorus, Lampropedia spp., Candidatus Accumulibacter phosphatis, Tetrasphaera spp., and combinations of these. In embodiments, suitable phosphorus accumulating organisms include Tetrasphaera elongata. In embodiments phosphorus accumulating organisms are added to wastewater treatment to bioaugment the conditions therein. In embodiments, phosphorus accumulating organisms pretreated by contacting them with carbon source prior to the addition to a wastewater stream are added to wastewater treatment to reduce or eliminate phosphorous therein. In embodiments, suitable phosphorus accumulating organisms include Tetrasphaera elongata pretreated with carbon source prior to use in the wastewater treatment.

In embodiments, suitable phosphorus accumulating organisms include Tetrasphaera elongata (without pretreatment in accordance with the present disclosure).

In embodiments the phosphorus accumulating organisms are characterized as exogenous. As used herein, “exogenous” refers to organisms that originate or are grown outside the wastewater treatment process being treated in accordance with the present disclosure. Non-limiting examples of exogenous phosphorus accumulating organisms include phosphorus accumulating organisms from any source other than the wastewater stream of interest, any phosphorus accumulating organisms pretreated with carbon source in accordance with the present disclosure, as well as any phosphorus accumulating organisms isolated from a wastewater treatment process and grown separately therefrom.

It has been surprisingly found that Tetrasphaera elongata in combination with specific carbon source is excellent at phosphorus removal from wastewater. Non-limiting examples of carbon sources include but are not limited to acetic acid, propionic acid, glycerol, glucose, molasses, high fructose corn syrup, and anaerobically digested material. In embodiments, the LP2 strain of T. elongata (DSM No.: 14184, Type strain) is excellent for use in accordance with the present disclosure. In embodiments, the LP2 strain of T. elongata (DSM No.: 14184, Type strain) in combination with glycerol carbon source is excellent for use in accordance with the present disclosure.

Further, it has been found that specifically targeting PAOs and contacting them with carbon source prior to applying to a wastewater treatment stream increases the efficiency of carbon source application and phosphorus removal. Without wishing to be bound by the present disclosure, application of carbon source to PAO's prior to application to the wastewater stream eliminates competition for the carbon source between the PAOs and microbes within the wastewater stream.

Non-limiting examples of phosphorus suitable for removal or elimination from a wastewater stream in accordance with the present disclosure include phosphorus dissolved in wastewater including bioavailable phosphorus and phosphorus that is bioavailable after degradation by microbes in a wastewater treatment process. Non-limiting examples of bioavailable phosphorus includes ortho phosphorus such as PO₄³⁻, HPO₄²⁻, H₂PO₄⁻, H₃PO⁴. Non-limiting examples of phosphorus that is bioavailable after degradation by microbes in a wastewater treatment process inorganic condensed phosphorus, organic phosphorus, chemically bound phosphorus and reduced phosphorus. Non-limiting examples of inorganic condensed phosphorus include pyrophosphate, tripolyphosphate, trimetaphosphate, and poly-phosohate granules. Non-limiting example of organic phosphorus includes influent cell material such as ATP. Non-limiting example of chemically bound phosphorus includes precipitant phosphorus complexes, absorbed phosphorus, metal phosphates such as iron phosphates, aluminum phosphates, or calcium phosphates, or higher metal complexes. Non-limiting examples of reduced phosphorus include phosphorus with oxidation number greater than 5, phosphides (oxidation number −3), diphosphide (oxidation number −2), tetraphosphide (−0.5), elemental P (oxidation number 0), hypophosphite (oxidation number +1), and phosphite (oxidation number +3).

In non-limiting embodiments, sewage wastewater for treatment in accordance with the present disclosure includes total phosphorus in the amount including 6-25 mg/L of total phosphorus in wastewater. In non-limiting embodiments, ortho-phosphorus is present in wastewater in the amount of 4-15 mg/L. Total phosphorous in sewage may vary depending upon geographical source of sewage. It is known that phosphorus in wastewater and sewage varies around the world.

In embodiments, methods of the present disclosure are useful for maintaining stability and upset recovery applications in wastewater treatment plants. Bioaugmentation with a PAO in accordance with the present disclosure will improve or stabilize phosphorus removal.

One of ordinary skill in the art understands that the dosing of PAO in wastewater varies depending upon the size and characteristics of the wastewater treatment plant. In embodiments, wastewater treatment is contacted with an amount of PAO sufficient to decrease phosphorus from the wastewater. For example, PAO such as T. elongate may be adjusted depending upon total phosphorus present in the wastewater. In embodiments, no less than 1×10¹ CFU/ml of exogenous PAO microorganism is needed to start the treatment processes in accordance with the present disclosure. In embodiments 1×10¹ to 1×10¹⁰ CFU/ml is suitable for the present disclosure. In embodiments 1×10² to 1×10⁸ CFU/ml is suitable for the present disclosure. In embodiments 1×10³ to 1×10⁵ CFU/ml is suitable for the present disclosure.

One of ordinary skill in the art understands that the dosing of carbon source in wastewater varies depending upon the size and characteristics of the wastewater treatment plant. In embodiments, wastewater treatment is contacted with an amount of carbon source sufficient to decrease phosphorus from the wastewater. For example, where concentration of phosphorus in wastewater is high such as between 10-12 mgP/L, carbon source can be added in the amount of between 0.4 g/L to 2 g/L of wastewater, for example 1 g/L of wastewater. In embodiments, carbon source is added in an amount between 0.1 g/L to 20 g/L of wastewater. In embodiments, carbon source is added in an amount between 0.2 to 10 g/L of wastewater.

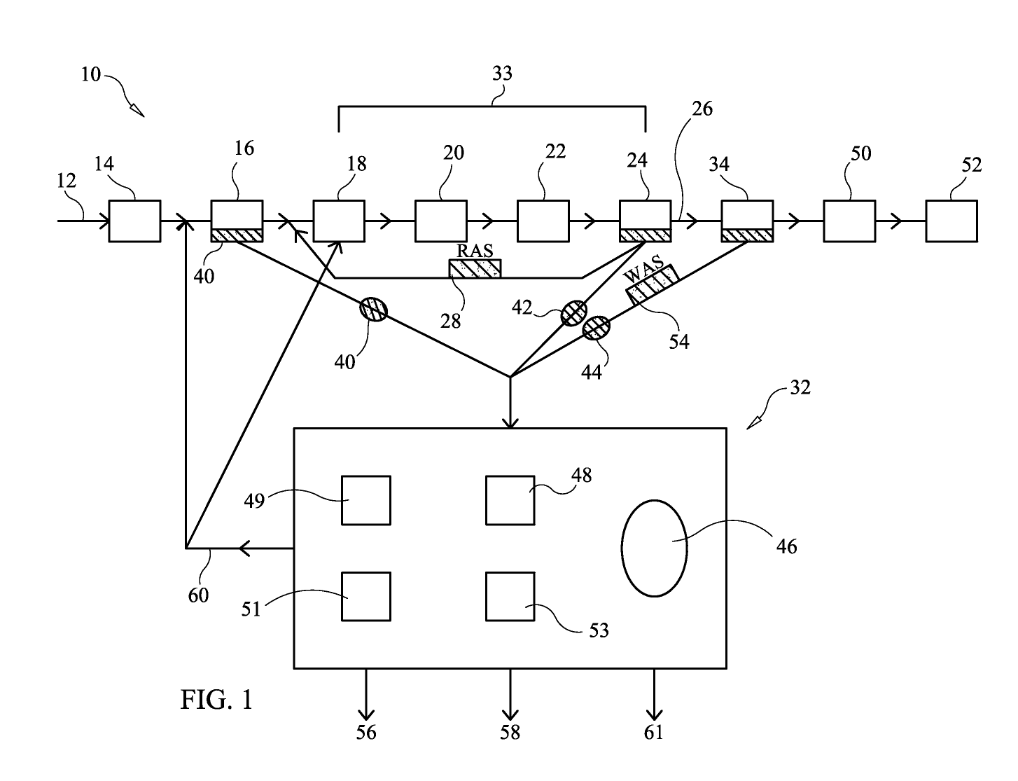

FIG. 1 illustrates a schematic view of a wastewater treatment process 10. More specifically, the wastewater treatment process 10 provides an energy and cost efficient method for the removal or elimination of phosphorus from plant influent wastewater 12. Carbon addition to known wastewater treatment processes is problematic given wastewater treatment systems treat many millions of gallons of wastewater, and the amount of carbon source (or other additives) required to increase carbon concentration by 1 mg/L to achieve better phosphorus removal is enormous and costly. Since many systems require vast quantities of carbon source and/or other additives, embodiments of the present disclosure require reduced amounts of dissolved carbon source or additives in comparison to amounts typically used in wastewater treatment systems. In embodiments of the present disclosure, phosphorus removal requires reduced amounts or no carbon source added to the process stream, as it uses bioaugmentation with exogenous PAO's to reduce or eliminate the need. In embodiments of the present disclosure, phosphorus removal requires reduced amounts or no additives such as metal salts added to the process stream, as it uses bioaugmentation to reduce or eliminate the need. In embodiments of the present disclosure, carbon source is reduced by pretreating or specifically targeting PAOs with carbon source prior to application to wastewater treatment 10.

In embodiments, phosphorus removal uses dissolved and particulate carbon (e.g., particulate organic matter from wastewater recycle, dewatered liquid from sludge or underflow) that is formed in the wastewater treatment process, instead of only external carbon source.

Referring back to FIG. 1 separate basins (such as basins 18, 20 and 22) are used to remove phosphorus from plant influent wastewater 12. As used herein, plant influent wastewater 12 is raw wastewater that has not yet been treated and therefore has not yet entered a wastewater treatment system, such as the wastewater treatment systems that are described herein. Once in the wastewater treatment system, or partially treated, the influent becomes mixed liquor as it flows through a treatment process.

As shown in FIG. 1, wastewater is subjected to a preliminary treatment 14 which screens out, grinds up, and/or separates debris in the wastewater. Here, debris such as gravel, plastics, and other objects are removed to conserve space within the treatment processes and to protect pumping and other equipment from clogs, jams or wear and tear. Non-limiting examples of suitable screens include bar screens or a perforated screen placed in a channel. Preliminary treatment 14 may also include a grit chamber suitable for the removal of debris such as sand, gravel, clay, and other similar materials. Aerated grit removal systems and cyclone degritters may also be employed.

Still referring to FIG. 1, after preliminary treatment 14, wastewater is subjected to primary clarifier 16. Here sedimentation occurs where the velocity of water is lowered below the suspension velocity causing the suspended particles to settle out of the water by gravity. Typical wastewater treatment plants include sedimentation in their treatment processes.

However, sedimentation may not be necessary in water with low amounts of suspended solids. Primary clarifier 16 may include different types of basins. Non-limiting examples of basins include rectangular basins which allow water to flow horizontally through a long tank, double-deck rectangular basins which are used to expand volume, while minimizing land area usage, square or circular sedimentation basins with horizontal flow, and/or solids-contact clarifiers, which combine coagulation, flocculation, and sedimentation within a single basin. Typical sedimentation basins suitable for use here have four zones including the inlet zone which controls the distribution and velocity of inflowing water, the settling zone in which the bulk of settling takes place, the outlet zone which controls the outflowing water, and the sludge zone in which the sludge collects. In FIG. 1, primary sludge 40 is shown in a sludge zone in primary clarifier 16 and after removal while being sent to sludge processing 32. In embodiments, primary clarification retention time is an amount of time sufficient to separate primary sludge 40 from the wastewater process stream. For example retention time may be between 4 hours to 7 days.

Still referring to FIG. 1, after the wastewater is subjected to primary clarifier 16 and the primary sludge 40 has been sufficiently settled or removed, the wastewater flows into secondary treatment 33. In embodiments, wastewater is subjected to a first anaerobic basin 18. Here the wastewater is mixed with the contents of the anaerobic basin and may be referred to as a mixed liquor. In embodiments, anaerobic basin 18 is a deep basin with sufficient volume to permit sedimentation of solids, to digest retained sludge, and to anaerobically reduce some of the soluble organic substrate. Anaerobic basin can be made of material such as earth, concrete, steel or any other suitable material. Anaerobic basin 18 is added downstream from the primary clarifier 16, and upstream to, or before the anoxic basin 20 and aerated basin 22. In embodiments, anaerobic basin 18 is not aerated, or heated. Optionally anaerobic basin 18 can be mixed. The depth of anaerobic basin 18 is predetermined to reduce the effects of oxygen diffusion from the surface, allowing anaerobic conditions to predominate. In embodiments, anaerobic basin 18 is used for treating wastewater including high strength organic wastewaters such as industrial or municipal wastewater and communities that have a significant organic load. Here, biochemical oxygen demand (BOD) removals greater than 50 percent are possible. In embodiments, the retention time in the anaerobic basin 18 is between 0.25 to 6 hours and a temperature of greater than 15 degrees C. In embodiments, the anaerobic basin 18 operates under anaerobic conditions where there is no molecular oxygen and no oxidized nitrogen species such as nitrite or nitrate. Here, anaerobic microorganisms in the absence of dissolved oxygen convert organic materials into readily degradable materials such as volatile fatty acids. In embodiments, anaerobic basin 18 produces biodegradable COD which is accumulated by POA's in their biomass. In embodiments, the anaerobic basin operates under anaerobic conditions suitable for exposing and contacting PAOs to carbon. In embodiments, heterotrophs make complex carbon more bioavailable.

Still referring to FIG. 1, wastewater leaves anaerobic basin 18 and flows into anoxic basin 20. Anoxic basin 20 operates under anoxic conditions. In embodiments, the wastewater process stream includes the anoxic basin 20 to promote denitrification of the wastewater, where nitrate is converted to nitrogen gas. Heterotrophic bacteria in anoxic basin 20 use the nitrate as an oxygen source under anoxic conditions to break down organic substances.

Under Anoxic Conditions:

Nitrates+Organics+Heterotrophic Bacteria=Nitrogen Gas, Oxygen and Alkalinity

In embodiments, anoxic basin 20 operates under any suitable conditions to promote anoxic conditions. Non-limiting examples include establishing an anoxic zone in an unaerated basin 20 where the dissolved oxygen levels are kept below 1 mg/L or as close, without reaching 0 mg/L as possible. In embodiments, oxygen levels are in the amount of 0.2 to 0.5 mg/L. The pH of the anoxic basin 20 should be close to neutral (7.0) and preferably not drop below 6.5. In embodiments, carbon source is applied to the anoxic basin in the amount where at least 2.86 mg COD are required per mg of NO₃—N removed. In embodiments, the anoxic basin operates at conditions favorable to heterotrophic bacteria including, but not limited to temperatures maintained within the range of 5 to 48° C., or at least above 5° C. The pH of anoxic basin 20 should range from 6.9 to 7.1, at least above 6.5. Alkalinity may range from 0 to 6000 mg/L. In embodiments, alkalinity may range from 0.0001 to 6000 mg/L.

Still referring to FIG. 1, wastewater process stream leaves the anoxic basin 20, and flows into the aerobic basin 22. In embodiments, aerobic basin 22 operates under any suitable conditions to promote aerobic conditions. Non-limiting examples of aerobic conditions include injecting air or oxygen into a wastewater process stream or mixed liquor to promote the biological oxidation thereof. In embodiments, surface aerators expose wastewater to air. In embodiments, the purpose of the basin is to biologically assist converting the soluble biodegradable organics in influent 12 (or mixed liquor passing through the treatment) to a biomass which is able to settle as sludge. Bacteria present in the aerobic basin 22 include those bacteria suitable in the degradation of organic impurities in an aerobic basin. Accordingly, in embodiments, aerobic treatment processes take place in the presence of air and utilize those microorganisms such as aerobes, which use molecular/free oxygen to assimilate organic impurities i.e. convert them in to carbon dioxide, water and biomass. In embodiments, the aerobic basin 22 operates at conditions favorable to aerobes including, but not limited to temperatures maintained within the range of 5 to 45° C., or at least above 5° C. The pH of aerobic basin 22 should range from 5 to 8.5, at least above 4. Alkalinity should range from 0 to 6000 mg/L. In embodiments, alkalinity may range from 0.0001 to 6000 mg/L.

Still referring to FIG. 1, wastewater leaves the aerobic basin 22 and flows into a secondary clarifier 24. Any suitable secondary clarifier can be used suitable for solid/liquid separation. Suitable secondary clarifiers 24 for use in accordance with the present disclosure separate and remove solids/biomass produced in biological process in a manner that suits process goals (rapid sludge removal, detention time, etc.). Secondary clarifier 24 may also be used to thicken solids for recirculation and process reuse and/or store biomass as buffer to prevent process upsets. All of the return and activated sludge is collected in the bottom of the secondary clarifier 24. FIG. 1 shows raw activated sludge or RAS 28 being pumped back into the system (e.g., upstream), as well as sludge 42 being pumped to sludge processing 32. In embodiments, in order to ensure enough bacteria are available to consume waste in wastewater, sludge is returned to the anaerobic tank 18 from secondary clarifier 24. This sludge is referred to as return activated sludge or RAS, 28 as shown in FIG. 1. The activated sludge will increase in quantity as it eats more organic material in the wastewater process stream.

Still referring to FIG. 1, wastewater leaves the secondary clarifier 24 and flows into tertiary treatment 34, disinfection 50 and discharge 52. In embodiments, sludge leaves the tertiary treatment 34 and flows or is pumped back into sludge processing 32. When there are too many bacteria it may become necessary to remove the excess quantity from the system. The excess microbiological life removed is termed waste activated sludge or WAS (54 in FIG. 1) or tertiary sludge 44 and is pumped to sludge processing 32. In embodiments, secondary sludge 42 is also sent to sludge processing.

In embodiments, activated sludge 28 is a stream that has been separated from the plant effluent. This activated sludge stream 28 contains a microbial mass, in addition to nitrates and dissolved oxygen. The microbial mass includes a variety of biological components, including bacteria, fungi, protozoa, rotifers, etc. While both heterotrophic and autotrophic microorganisms may reside in activated sludge, heterotrophic microorganisms typically predominate. Heterotrophic microorganisms obtain energy from carbonaceous organic matter in plant influent wastewater for the synthesis of new cells. These microorganisms then release energy via the conversion of organic matter into compounds, such as carbon dioxide and water. Autotrophic microorganisms in activated sludge 28 generally reduce oxidized carbon compounds, such as carbon dioxide, for cell growth. These microorganisms obtain their energy by oxidizing ammonia to nitrate, known as nitrification.

In accordance with the present disclosure, PAOs can be added to a wastewater system at various points in the process stream. For example, referring to FIG. 1, PAOs can be added alone, in combination with carbon source, or pretreated with carbon source into anaerobic tank 18, anoxic tank 20, aerobic tank 22, recycle activated sludge stream 28, or side stream 60. According to FIG. 1, side stream 60 can be connected to primary clarifier 16 or anaerobic basin 18. PAO's are added to the anaerobic tank 18, anoxic tank 20, aerobic tank 22, raw activated sludge stream 28, or side stream 60 in an amount sufficient to increase phosphorus removal from the wastewater process stream or mixed liquor. As used herein, increased phosphorus removal means that phosphorus from a wastewater treatment process in accordance with the present disclosure has more phosphorus entering sludge such as secondary sludge compared to the same wastewater treatment process without PAO's and/or carbon sources or pretreated PAO's of the present disclosure. In embodiments, phosphorus removal is 1×, 2×, 3×, 4×, 5×, 10×, 20×, 30×, 40×, 50× more than the same wastewater treatment process without the PAO's and/or carbon sources or pretreated PAO's of the present disclosure.

In embodiments, PAO's are added or dosed into the mixed liquor or process stream in an amount sufficient to increase phosphorus removal from the wastewater process stream or mixed liquor. In accordance with the present disclosure, phosphorus release and phosphorus uptake refer to the process of phosphorus accumulating organisms (PAOs) storing polyphosphate as an energy reserve in intracellular granules. In embodiments, PAOs are added directly to the anaerobic basin 18. In anaerobic conditions, PAOs release orthophosphate, using the energy to accumulate simple organics and store them as polyhydroxyalkanoates (PHAs) or some other form of intracellular carbon. In aerobic conditions, or at least conditions where there is some oxygen, nitrites, or nitrates present, the PAOs hydrolyze the stored organic material, using some of the energy to take up orthophosphate and store it as polyphosphate. As such, when the PAOs store extra carbon, the PAOs may also release intracellular phosphorus, sometimes simultaneously. When the PAOs use stored carbon, they uptake phosphorus using nitrate, nitrite or oxygen as an electron acceptor. In embodiments of the present disclosure, where low levels of oxygen are found in the wastewater treatment process, PAO's will uptake phosphorus. When oxygen, nitrite, or nitrate is present, the PAOs can get energy out of the carbon. Therefore when carbon is abundant, the PAOs store it in their cells and wait until there are conditions where an electron acceptor is present so that they can use the carbon for phosphorus uptake. The phosphate is then removed in the waste activated sludge 54, which is generally the activated sludge that is not recycled to the anaerobic tank 18.

In embodiments, PAO addition takes place in the anaerobic tank 18. As shown in FIG. 1, plant influent wastewater 12 is mixed with return activated sludge 28 in anaerobic tank 18. This causes a mixed liquor to form which is sent downstream through anoxic tank 20, aerobic tank 22, and finally to a secondary clarifier 24. Exiting from the secondary clarifier 24 is treated plant effluent 26, activated sludge 28 and waste activated sludge 54. A portion of the activated sludge 28 is again recycled to the anaerobic basin as return activated sludge 28. Waste activated sludge 54, is sent to sludge processing 32.

Referring back to FIG. 1, primary 40, secondary 42, tertiary sludge 44 enter sludge processing 32. Here, sludge, including sludge from anaerobic digestion 46 is subjected to thickening 48, conditioning 49, dewatering 51 and stabilization 53. In embodiments, dewatering occurs through drying sludge which may include the addition of polymers to aid in the dewatering. Alternatively, the sludge can be heated or frozen and thawed to increase the solids concentration. Treating the sludge to aid in thickening is known as conditioning the sludge. Once the sludge has been conditioned, it may be thickened in a lagoon, drying bed, or one of several other devices. After an effective duration (which can be months) the sludge may be reduced up to 10 to 50% solid state and sent off for incineration 56, land application 58 or land fill 61. Sludge may be disposed of in a sewer or stream or may be conditioned and then thickened in a lagoon, drying bed, filter press, belt filter press, centrifuge, or vacuum filter before being transported to a landfill or land application site. In embodiments, a liquid stream or underflow is sent by way of side stream 60 back into primary or secondary treatment 33. In embodiments, side stream 60 can be sent directly to the anoxic or aerobic basin 20 or 22 (not shown in FIG. 1).

In accordance with the present disclosure phosphorus accumulating organisms in combination with one or more carbon sources are added to a process of treating wastewater. The process includes contacting a wastewater process stream with one or more exogenous phosphorus accumulating organisms in combination with one or more carbon sources to form a mixed liquor, wherein the one or more exogenous phosphorus accumulating organisms uptake phosphorus from the mixed liquor, and separating the one or more exogenous phosphorus accumulating organisms from the mixed liquor. As used herein, the term “bioaugment” refers to addition of exogenous microorganisms to a system for improving its performance. Accordingly, bioaugmented phosphorus accumulating organisms refers to the addition of exogenous PAO's to a system or wastewater treatment process for improving its performance. Non-limiting examples of improved performance include improved stability of a wastewater treatment process or improved phosphorus removal. In embodiments, wastewater treatment process is improved in that reduced amounts of carbon source is used compared to wastewater treatment process not in accordance with the present disclosure. In embodiments, carbon source addition is reduced by 10-100%. In embodiments, carbon source addition is reduced by 1%, 2%, 3%, 4%, 5%, 6%, 7%, 8%, 9%, or 10%. In embodiments, carbon source is eliminated from the process, such that no carbon source is added to the treatment. In embodiments, carbon source is reduced by pre-treating PAO's with carbon source prior to contact with the wastewater treatment stream.

In accordance with the present disclosure, carbon sources can be added to a wastewater system at various points in the process stream or mixed liquor. For example, referring to FIG. 1, carbon source can be added alone, or in combination with anaerobic tank 18, anoxic tank 20, aerobic tank 22, raw activated sludge stream 28, or side stream 60. For example, carbon sources including to acetic acid, propionic acid, glycerol, glucose, molasses, high fructose corn syrup, methanol, high carbonaceous industrial waste and combinations thereof can be added to the wastewater treatment 10. Carbon sources are added to the process stream in an amount sufficient to maintain or nourish bacterial conditions therein. For example, carbon source can be added in an amount of 1 mg/L to 1000 mg/L of wastewater process stream, underflow or water separated from sludge. In embodiments, at least 3 or more mg/L carbon source per mg/L phosphorus to be removed is added in accordance with the present disclosure. In embodiments, at least 1 or more mg/L carbon source per mg/L phosphorus to be removed is added in accordance with the present disclosure. In embodiments, at least 3 or more mg/L carbon source per mg/L phosphorus to be removed is added in accordance with the present disclosure.

In embodiments, Tetrasphaera elongata in combination with specific carbon source is excellent at phosphorus removal from wastewater treatment as shown in FIG. 1. Non-limiting examples of carbon sources include but are not limited to acetic acid, propionic acid, glycerol, glucose, molasses, high fructose corn syrup, methanol and carbonaceous industrial waste. In embodiments, the LP2 strain of T. elongata (DSM No.: 14184, Type strain) alone is excellent for use in accordance with the present disclosure. In embodiments, the LP2 strain of T. elongata (DSM No.: 14184, Type strain) is excellent for use in accordance with the present disclosure in combination with one or more carbon sources selected from the group consisting of acetic acid, propionic acid, glycerol, glucose, molasses, high fructose corn syrup, methanol, carbonaceous industrial waste and combinations thereof.

Embodiments of the present disclosure can be applied to a variety of known wastewater treatment plants, and many known configurations are possible. For example, secondary treatment can include combinations of basins other than the embodiments shown in FIG. 1 that uses, in sequence, an anaerobic basin, anoxic basin and aerobic basin. Non-limiting examples of alternative wastewater treatment processes include those processes where secondary treatment only includes one or more anoxic and one or more aerobic basins, or only one or more anaerobic and one or more aerobic basins. Basins can be set up in a variety of ways known to one of ordinary skill in the art. In embodiments, only one or more aerobic basins are used in secondary treatment.

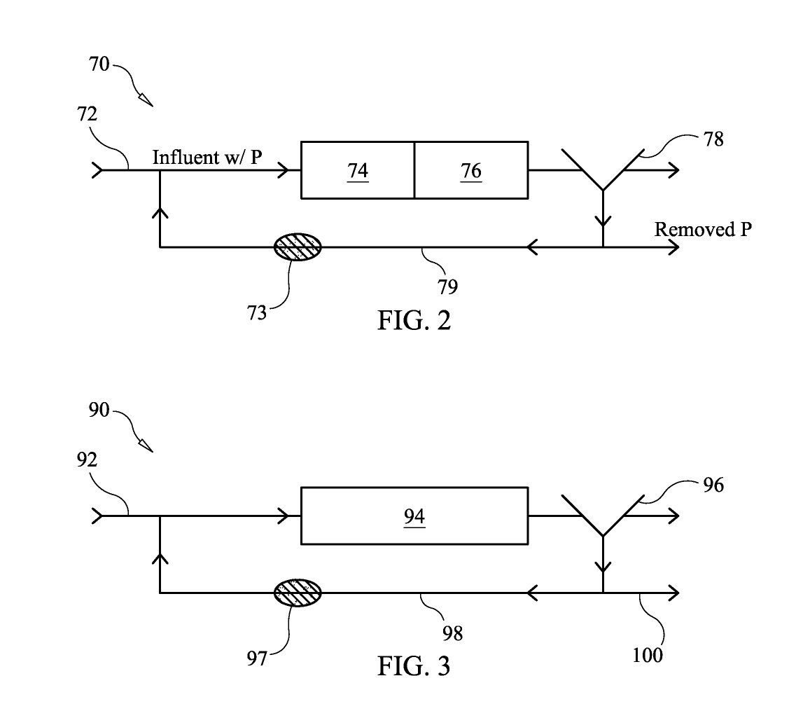

FIG. 2 illustrates a schematic view of another wastewater treatment process 70 in accordance with the present disclosure. Here, wastewater influent with phosphorus 72 flows into anaerobic basin 74, then to aerobic basin 76, and then to a secondary clarifier 78. In embodiments, anaerobic basin 74 operates under any suitable conditions to promote anaerobic conditions. In embodiments, anaerobic basin 74 produces biodegradable COD which is accumulated by POA's in their biomass. In embodiments, the anaerobic basin operates under anaerobic conditions suitable for exposing and/or contacting PAOs to carbon. In embodiments, heterotrophs make complex carbon more bioavailable.

Still referring to FIG. 2, wastewater leaves anaerobic basin 74 and flows into the aerobic basin 76. In embodiments, aerobic basin 76 operates under any suitable conditions to promote aerobic conditions. Non-limiting examples of aerobic conditions include injecting or contacting air or oxygen into a wastewater process stream or mixed liquor to promote the biological oxidation thereof. In embodiments, the purpose of the basin is to biologically assist converting the soluble biodegradable organics in influent 72 to either gases or a biomass which is able to settle as sludge. Bacteria present in the aerobic basin 76 include those bacteria suitable in the degradation of organic impurities in an aerobic basin. Accordingly, in embodiments, aerobic treatment processes take place in the presence of air and utilize those microorganisms such as aerobes, which use molecular/free oxygen to assimilate organic impurities i.e. convert them in to carbon dioxide, water and biomass. In embodiments, the aerobic basin operates at conditions favorable to aerobes including, but not limited to temperatures maintained within the range of 5 to 55° C., or at least above 5° C.

Still referring to FIG. 2, PAOs can be added to underflow 79 including return activated sludge 73, anaerobic basin 74 and/or aerobic basin 76. PAO's are added in an amount sufficient to increase phosphorus accumulation in secondary sludge. PAO's are added in an amount sufficient to reduce phosphorus in discharged treated wastewater. Raw activated sludge is removed from the secondary clarifier and either returned to anaerobic basin 74, or discharged through sludge processing (not shown in FIG. 2). In accordance with the present disclosure, PAO's are added to the mixed liquor of the process stream and ultimately end up in the aerobic basin 76.

In accordance with the present disclosure, carbon sources can be added to a wastewater system at various points in the process stream or mixed liquor. For example, referring to FIG. 2, carbon source can be added alone, or in combination with anaerobic tank 74, aerobic tank 76, raw activated sludge 73, or side stream 79 which may include underflow. For example, carbon sources including to acetic acid, propionic acid, glycerol, glucose, molasses, high fructose corn syrup, methanol, industrial carbonaceous waste and combinations thereof can be added to the wastewater treatment 70. Carbon sources are added to the process stream in an amount sufficient to maintain or nourish bacterial conditions therein. For example, carbon source can be added in an amount of 1 mg/L to 1000 mg/L of wastewater process stream or underflow. In embodiments, at least 3 or more mg/L carbon source per mg/L phosphorus to be removed is added in accordance with the present disclosure. In embodiments, at least 2 or more mg/L carbon source per mg/L phosphorus to be removed is added in accordance with the present disclosure. In embodiments, at least 1 or more mg/L carbon source per mg/L phosphorus to be removed is added in accordance with the present disclosure.

In embodiments, Tetrasphaera elongata in combination with specific carbon source is excellent at phosphorus removal from wastewater treatment as shown in FIG. 2. Non-limiting examples of carbon sources include but are not limited to acetic acid, propionic acid, glycerol, glucose, molasses, high fructose corn syrup, industrial carbonaceous waste and methanol. In embodiments, the LP2 strain of T. elongata (DSM No.: 14184, Type strain) alone is excellent for use in accordance with the present disclosure. In embodiments, the LP2 strain of T. elongata (DSM No.: 14184, Type strain) is excellent for use in accordance with the present disclosure in combination with one or more carbon sources selected from the group consisting of glycerol, glucose, molasses, high fructose corn syrup, methanol, industrial carbonaceous waste and combinations thereof. In embodiments, the LP2 strain of T. elongata (DSM No.: 14184, Type strain) is excellent for use in accordance with the present disclosure in combination with glycerol.

In embodiments, exogenous Tetrasphaera elongata pre-treated with specific carbon source is excellent at phosphorus removal from wastewater treatment as shown in FIG. 2. Non-limiting examples of carbon sources include but are not limited to acetic acid, propionic acid, glycerol, glucose, molasses, high fructose corn syrup, industrial carbonaceous waste and methanol. In embodiments, pretreating the LP2 strain of T. elongata (DSM No.: 14184, Type strain) with carbon source selected from the group consisting of glycerol, glucose, molasses, high fructose corn syrup, methanol, industrial carbonaceous waste and combinations thereof is excellent for use in accordance with the present disclosure.

FIG. 3 illustrates a schematic view of another wastewater treatment process 90 in accordance with the present disclosure. Here, wastewater influent with phosphorus 92 flows into aerobic basin 94, then to a secondary clarifier 96. In embodiments, aerobic basin 94 operates under any suitable conditions to promote aerobic conditions. Non-limiting examples of aerobic conditions include injecting air or oxygen into a wastewater process stream or mixed liquor to promote the biological oxidation thereof. In embodiments, the purpose of the basin is to biologically assist converting the soluble biodegradable organics in influent 92 to a biomass which is able to settle as sludge. Bacteria present in the aerobic basin 94 include those bacteria suitable in the degradation of organic impurities in an aerobic basin. Accordingly, in embodiments, aerobic treatment processes take place in the presence of air and utilize those microorganisms such as aerobes, which use molecular/free oxygen to assimilate or oxidize organic impurities i.e. convert them in to carbon dioxide, water and biomass. In embodiments, the aerobic basin operates at conditions favorable to aerobes including, but not limited to temperatures maintained within the range of 5 to 55° C., or at least above 5° C. The pH of aerobic basin 94 should range from 5 to 8.5, at least above 5. Alkalinity should range from 0 to 6000 mg/L. In embodiment, alkalinity ranges from 0.001 to 6000 mg/L.

Still referring to FIG. 3, exogenous PAOs can be added to underflow 98 including return activated sludge, and/or aerobic basin 94. PAO's are added in an amount sufficient to increase phosphorus accumulation in secondary sludge. In embodiments, exogenous PAO's are added in an amount sufficient to reduce phosphorus in discharged treated waste water. Raw activated sludge 100 is removed from the secondary clarifier and either returned to secondary treatment, or discharged through sludge processing (not shown in FIG. 3). In accordance with the present disclosure, PAO's are added to the mixed liquor of the process stream and ultimately end up in the aerobic basin.

In accordance with the present disclosure, carbon sources can be added to a wastewater system at various points in the process stream or mixed liquor. For example, referring to FIG. 3, carbon source can be added alone, or in combination with aerobic tank 94, raw activated sludge 97, or side stream 98. For example, carbon sources including acetic acid, propionic acid, glycerol, glucose, molasses, high fructose corn syrup, methanol, industrial carbonaceous waste and combinations thereof can be added to the wastewater treatment 90. Carbon sources are added to the process stream in an amount sufficient to maintain bacterial conditions therein. For example, carbon source can be added in an amount of 1 g/L to 1000 g/L of wastewater process stream or underflow. In embodiments, at least 3 or more mg/L carbon source per mg/L phosphorus to be removed is added in accordance with the present disclosure. In embodiments, at least 2 or more mg/L carbon source per mg/L phosphorus to be removed is added in accordance with the present disclosure. In embodiments, at least 1 or more mg/L carbon source per mg/L phosphorus to be removed is added in accordance with the present disclosure.

In embodiments, exogenous Tetrasphaera elongata in combination with specific carbon source is excellent at phosphorus removal from wastewater treatment as shown in FIG. 3. Non-limiting examples of carbon sources include but are not limited to acetic acid, propionic acid, glycerol, glucose, molasses, high fructose corn syrup, industrial carbonaceous waste and methanol. In embodiments, the LP2 strain of T. elongata (DSM No.: 14184, Type strain) alone is excellent for use in accordance with the present disclosure. In embodiments, the LP2 strain of T. elongata (DSM No.: 14184, Type strain) is excellent for use in accordance with the present disclosure in combination with one or more carbon sources selected from the group consisting of glycerol, glucose, molasses, high fructose corn syrup, methanol, industrial carbonaceous waste and combinations thereof. In embodiments, the LP2 strain of T. elongata (DSM No.: 14184, Type strain) is excellent for use in accordance with the present disclosure with glycerol.

In embodiments, Tetrasphaera elongata pre-treated with specific carbon source is excellent at phosphorus removal from wastewater treatment as shown in FIG. 3. Non-limiting examples of carbon sources include but are not limited to acetic acid, propionic acid, glycerol, glucose, molasses, high fructose corn syrup, industrial carbonaceous waste and methanol. In embodiments, pretreating the LP2 strain of T. elongata (DSM No.: 14184, Type strain) with carbon source selected from the group consisting of glycerol, glucose, molasses, high fructose corn syrup, methanol, industrial carbonaceous waste and combinations thereof is excellent for use in accordance with the present disclosure.

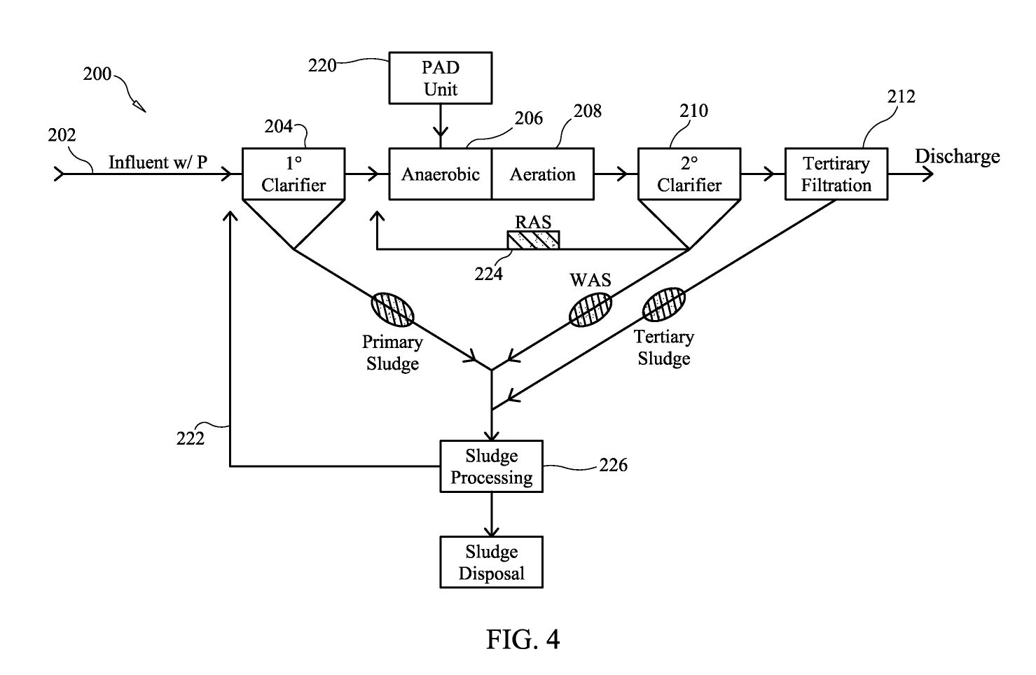

Referring now to FIG. 4, a schematic view of enhanced biological phosphorus removal using phosphate accumulating organism and carbon source in one embodiment of the present disclosure is illustrated. This non-limiting configuration is suitable for enhanced biological phosphorus removal (EBPR) upset recovery. Non-limiting benefits of this configuration include: reduced or eliminated metals for recovery making EBPR recovery easier; reduced amounts of overall sludge; and in embodiments, tertiary filtration becomes less expensive and disinfection more economical. Here, the wastewater treatment process 200 provides an energy and cost efficient method for the removal or elimination of phosphorus from plant influent wastewater 202. In embodiments of the present disclosure, carbon source is reduced by pretreating or specifically targeting PAOs with carbon source prior to contact with wastewater influent 202 or process stream thereof. Referring to FIG. 4, wastewater influent with phosphorus 202 flows into primary clarifier 204, anaerobic basin 206, aerobic basin 208, secondary clarifier 210, followed by tertiary filtration 212 and discharge. In embodiments, anaerobic basin 206 operates under any suitable conditions to promote anaerobic conditions. In embodiments, anaerobic basin 206 produces biodegradable COD which is accumulated by POA's in their biomass. In embodiments, pre-acclimation device 220 or PAD unit is connected to the anaerobic basin 206. Pre-acclimation device 220 may be in the form of a bucket, drum or tank depending upon the size of the wastewater treatment facility. In pre-acclimation device 220, PAOs are pretreated, or contacted with carbon source prior to insertion into the wastewater stream. One of ordinary skill in the art may vary the conditions of pre-acclimation device 220, however the purpose of the device is to target PAOs with carbon source prior to addition to anaerobic basin 206. In embodiments, PAD unit 220 includes water at room temperature with a neutral pH. In embodiments, the contents of PAD unit 220 medium are near anaerobic conditions such that there is no active aeration. In embodiments, carbon source is added to PAD unit 220 in an amount sufficient to pretreat PAO's deposited therein. One of ordinary skill in the art understands that the amount of PAO's added to PAD unit 220 will vary depending upon the size of the plant. In embodiments, such as when freeze-dried pretreated PAOs in accordance with the present disclosure are used, the freeze-dried composition is added to PAD unit 220 in an amount of at least 0.1 KG of freeze-dried composition. In embodiments, at least 10, 20 or 30 KG of PAO material is added per day to a PAD unit. One non-limiting example would include adding PAO in the amount of at least 4 KG per day to a PAD unit of a plant capable of treating 10 million gallons of wastewater per day.

After application of carbon source and POA's to PAD unit 220, a retention time of 1-3 hours under anaerobic condition (no active aeration) is typically needed for the PAO's to be sufficiently pre-treated such that they have taken up carbon source internally. In embodiments, Tetrasphaera elongate is added to pre-acclimation device 220 with a carbon source such as acetic acid, propionic acid, glycerol, glucose, molasses, high fructose corn syrup, industrial carbonaceous waste and methanol. In embodiments, the LP2 strain of T. elongata (DSM No.: 14184, Type strain) in combination with glycerol is excellent for use in accordance with the pre-acclimation device 220 of the present disclosure. In embodiments, the LP2 strain of T. elongata (DSM No.: 14184, Type strain) is excellent for use in the pre-acclimation device 220 in accordance with the present disclosure in combination with one or more carbon sources selected from the group consisting of glycerol, glucose, molasses, high fructose corn syrup, methanol, industrial carbonaceous waste and combinations thereof. Under conditions where carbon source is not entirely acquired by the PAO's, left over carbon source is simply added with the pre-treated PAO's into anaerobic basin 206 where it continues to be available to the PAOs.

Still referring to FIG. 4, wastewater leaves anaerobic basin 206 and flows into the aerobic basin 208. In embodiments, aerobic basin 208 operates under any suitable conditions to promote aerobic conditions. Non-limiting examples of aerobic conditions include injecting or contacting air or oxygen into a wastewater process stream or mixed liquor to promote the biological oxidation thereof. In embodiments, the purpose of the basin is to biologically assist converting the soluble biodegradable organics in influent 202 to either gases or a biomass which is able to settle as sludge. Bacteria present in the aerobic basin 202 include those bacteria suitable in the degradation of organic impurities in an aerobic basin. Accordingly, in embodiments, aerobic treatment processes take place in the presence of air and utilize those microorganisms such as aerobes, which use molecular/free oxygen to assimilate organic impurities i.e. convert them in to carbon dioxide, water and biomass. In embodiments, the aerobic basin operates at conditions favorable to aerobes including, but not limited to temperatures maintained within the range of 5 to 55° C., or at least above 5° C.

Still referring to FIG. 4, pretreated PAOs can be added to underflow 222 (not shown in FIG. 4) including return activated sludge 224, anaerobic basin 206 and/or aerobic basin 208. PAO's are added in an amount sufficient to increase phosphorus accumulation in secondary sludge. PAO's are added in an amount sufficient to reduce phosphorus in discharged treated wastewater. Raw activated sludge is removed from the secondary clarifier 210 and either returned to anaerobic basin 206, or discharged through sludge processing 224. In accordance with the present disclosure, pretreated PAO's are added to the mixed liquor of the process stream and ultimately end up in the aerobic basin 208.

In accordance with the present disclosure, carbon sources can be added to pre-acclimation device 220 prior to injection in the process stream or mixed liquor. For example, referring to FIG. 4, carbon source can be added alone, or in combination with PAO's to pre-acclimation device 220. For example, carbon sources including to acetic acid, propionic acid, glycerol, glucose, molasses, high fructose corn syrup, methanol, industrial carbonaceous waste and combinations thereof can be added to pre-acclimation device 220. Carbon sources are added to the process stream in an amount sufficient to maintain or nourish PAO conditions therein. For example, carbon source can be added in an amount of 1 mg/L to 1000 mg/L of PAO admixture. In embodiments, at least 3 or more mg/L of carbon source is added to the PAD unit 220 in accordance with the present disclosure. In embodiments, at least 2 or more mg/L of carbon source is added to the PAD unit 220 in accordance with the present disclosure. In embodiments, at least 1 or more mg/L of carbon source is added to the PAD unit 220 in accordance with the present disclosure.

In embodiments, Tetrasphaera elongata in combination with specific carbon source is excellent for pretreatment in the PAD unit 220 as shown in FIG. 4. Non-limiting examples of carbon sources include but are not limited to acetic acid, propionic acid, glycerol, glucose, molasses, high fructose corn syrup, industrial carbonaceous waste and methanol. In embodiments, the LP2 strain of T. elongata (DSM No.: 14184, Type strain) is excellent for use as a pre-mixture in accordance with the present disclosure in combination with one or more carbon sources selected from the group consisting of glycerol, glucose, molasses, high fructose corn syrup, methanol, industrial carbonaceous waste and combinations thereof.

FIGS. 1, 2, 3 and 4 are non-limiting examples of the process in accordance with the present disclosure where PAO's, or pretreated PAO's increase phosphorus removal and bioaugment a wastewater process stream. However, the process of the present disclosure can be used in a number of scenarios. For example, in one embodiment, depending on the conditions of the wastewater, bioaugmented PAO's, underflow and carbon source can contact the wastewater process stream to remove phosphorus from wastewater. In another embodiment, depending on the conditions of the wastewater, only bioaugmented PAO's and dewatered sludge recycle or underflow is contacted with the wastewater process stream to remove phosphorus from wastewater. This is appropriate when no additional carbon source is needed. In embodiments, PAO's are pretreated by contacting them with carbon prior to contacting them with the wastewater stream. In another scenario, it is possible that one of ordinary skill in the art could determine that the wastewater influent already contains a sufficient amount of carbon source. For examples, carbon source can be added to fermentation broth so that PAO's in accordance with the present disclosure have carbon source already stored therein. In embodiments, whole broth fermentation could include the carbon source so that no additional carbon source needs to be added to the wastewater process stream.

Accordingly the methods and compositions of the present disclosure is suitable for application in several non-limiting scenarios:
the processes of the present disclosure are suitable for an application scenario where wastewater already has carbon source (so no carbon acclimation/addition is required at the wastewater treatment facility).
the processes of the present disclosure are suitable for an application scenario where carbon source is added to the wastewater process stream in accordance with the present disclosure at the wastewater treatment plant of site.
the processes of the present disclosure are suitable for an application scenario where a carbon source is mixed with compositions of the present disclosure before bioaugmentation on the treatment site.
the processes of the present disclosure are suitable for an application scenario where PAO is fermented or formulated with carbon in the biomass so that no additional carbon addition is required at the wastewater treatment site.

In embodiments, carbon source is added to the wastewater process stream or mixed liquor in an amount sufficient to remove phosphorus from wastewater. In embodiments, one of ordinary skill in the art determines how much phosphorus needs to be removed from the wastewater. In embodiments, at least 3 or more mg/L carbon source per mg/L phosphorus to be removed is added to the process stream. In embodiments, 3 or more mg/L of carbon source per mg/L of phosphorus are added to the wastewater treatment process. In embodiments, one of ordinary skill in the art would use at least 10-15 mg/L of readily biodegragable COD per mg/L of phosphorous.

In embodiments, the disclosed composition may be in the form of a liquid. In one aspect, the amount of the at least one PAO microorganism in the composition may be from 1×10¹ to 1×10¹⁰ CFU/ml, or from 1×10⁴ to 1×10⁸ CFU/ml. In another aspect, the amount of the at least one PAO microorganism in the composition is about 1×10⁶ CFU/ml, about 1×10⁷ CFU/ml, about 1×10⁸ CFU/ml, or about 1×10⁹ CFU/ml. When the composition contains different microorganisms, the CFU is calculated by adding the CFUs of each microorganism. When cell-free supernatant (CFS) is used, the supernatant obtained directly from the PAO microorganism is considered as the original CFS (1:1).

In embodiments, compositions include Tetrasphaera elongata in combination with specific carbon source. Non-limiting examples of carbon sources include but are not limited to acetic acid, propionic acid, glycerol, glucose, molasses, high fructose corn syrup, industrial carbonaceous waste and methanol. In embodiments, the LP2 strain of T. elongata (DSM No.: 14184, Type strain) is combined with carbon sources including but are not limited to acetic acid, propionic acid, glycerol, glucose, molasses, high fructose corn syrup, industrial carbonaceous waste and methanol.

Suitable embodiments of composition of the present disclosure include freeze dried compositions of PAO's in accordance with the present disclosure. For example, freeze dried PAO's may be contacted with lyoprotectant to form a stable formulation. Suitable lyoprotectants include carbohydrates, maltodextrin, skim milk, sucrose and combinations thereof.

Suitable embodiments of composition of the present disclosure include freeze dried compositions including pre-treated PAO's in accordance with the present disclosure. For example, freeze dried pre-treated PAO's may be contacted with lyoprotectant to form a stable formulation. Suitable lyoprotectants include carbohydrate, maltodextrin, skim milk, sucrose and combinations thereof. In embodiments, the PAO's are pretreated by contacting them with carbon sources such as acetic acid, propionic acid, glycerol, glucose, molasses, high fructose corn syrup, industrial carbonaceous waste and methanol.

Suitable embodiments of composition of the present disclosure include freeze dried compositions including pre-treated PAO's in accordance with the present disclosure. For example, freeze dried pre-treated PAO's may be contacted with lyoprotectant to form a stable formulation. Suitable lyoprotectants include maltodextrin, skim milk, sucrose and combinations thereof. In embodiments, the PAO's are pretreated by contacting them with carbon sources such as acetic acid, propionic acid, glycerol, glucose, molasses, high fructose corn syrup, industrial carbonaceous waste and methanol. In embodiments, the pretreated PAO is Tetrasphaera elongate.

Suitable embodiments of composition of the present disclosure include freeze dried compositions including pre-treated Tetrasphaera elongate in accordance with the present disclosure. For example, freeze dried pre-treated Tetrasphaera elongate may be contacted with lyoprotectant to form a stable formulation. Suitable lyoprotectants include carbohydrate, maltodextrin, skim milk, sucrose and combinations thereof.

In embodiments, lyoprotectant such as carbohydrate, maltodextrin, skim milk, sucrose alone or incombination are added to a freeze-dried composition in the amount of 2-50% of the total weight of the freeze-dried composition. In embodiments, lyoprotectant such as carbohydrate, maltodextrin, skim milk, sucrose alone or incombination are added to a freeze-dried composition in the amount of 20-30% of the total weight of the freeze-dried composition. In embodiments, maltodextrin is added to a freeze-dried composition in the amount of 20-30% of the total weight of the freeze-dried composition.

The following non-limiting examples further illustrate compositions, methods, and treatments in accordance with the present disclosure. It should be noted that the disclosure is not limited to the specific details embodied in the examples.

### EXAMPLES

### Example 1 (PAO Pure Culture and Bioaugmentation Batch Study)

Example 1 was performed to see whether the strain LP2 Tetrasphaera elongata (DSM No.: 14184, Type strain) shows typical polyphosphate accumulating organism (PAO) behavior and check if bioaugmenting with the strain stored in glycerol improves the biological phosphorus uptake activity of an activated sludge sample in batch assays.

### Materials and Methods:

The LP2 strain of T. elongata (DSM No.: 14184, Type strain) was grown in 1 L of a rich medium (composition given in Table 1 below) over 72 hrs. at 28±1° C.

TABLE 1
Rich medium composition used for growing T. elongata.

| Chemical | Concentration, g/L |
|---|---|
| Peptone | 10 |
| Yeast Extract | 5 |
| Casamino Acids | 5 |
| Beef Extract | 2 |
| Malt Extract | 5 |
| Glycerol | 2 |
| MgSO₄—7H₂O | 1 |
| Tween 80 | 0.05 |
| Water | 1000 |

The culture was then centrifuged at 8000 rpm, 10 min, at 4° C. The supernatant was discarded in a sterile environment and autoclaved glycerol was added to the centrifuged biomass so that the final concentration of the glycerol in the centrifuged biomass was 50% (v/v). Multiple 1 mL aliquots of this mixture were prepared using 1.5 mL sterile screw-cap vials and stored in the freezer at −80° C. Approximately 30 mL of the non-frozen biomass-glycerol mixture was autoclave-sterilized (twice) at 120° C. for 30 min each. This autoclaved portion of the culture was later used for augmenting the non-bioaugmented control assays for ensuring approximately equal amount of carbon addition to the bioaugmented and the non-bioaugmented control assays. Two liter of mixed liquor suspended solids (MLSS) was isolated from lab-scale sequencing batch reactors (SBRs) operated in the enhanced biological phosphorus removal (EBPR) mode using medium mentioned in Table 2 below. The original sludge for starting these SBR was obtained from a municipal wastewater treatment plant. The MLSS was allowed to settle down for 30 min by gravity and the supernatant was decanted and eventually discarded. The discarded supernatant roughly accounted for the 50% of the initial volume. The decanted volume of this MLSS was replaced with a phosphorous (all in the form of reactive) and COD rich sterile synthetic wastewater medium (composition given in Table 2 below.)

TABLE 2
Phosphorus and COD rich media used for the experiment.

| Chemical | Concentration, g/L |
|---|---|
| Peptone | 4.8 |
| Beef Extract | 3.3 |
| Yeast Extract | 1.12 |
| Glucose | 5.62 |
| K₂HPO₄ | 2 |
| NaCl | 0.28 |
| CaCl₂—2H₂O | 0.16 |
| MgSO₄—7H₂O | 0.08 |
| NaHCO₃ | 2 |

Three sets of 500 mL glass serum bottles were used for the test. Each set had five replicates in it. First set was used for the active pure culture study, the second set was used as the bioaugmented wastewater MLSS assay and the third set was used as the non-bioaugmented wastewater MLSS assay.

Each pure culture batch assay (set one) was supplied with 100 mL of the sterile phosphorus rich synthetic wastewater media, while the other bottles (set two and three) were supplied with 100 mL of the MLSS and synthetic wastewater media mixture. The pure T. elongata culture was taken out of the −80° C. freezer and thawed at the room temperature. The pure culture and the bioaugmented MLSS assay bottles were supplied with 1 mL of the concentrated active T. elongata culture, while the non-bioaugmented bottles were supplied with 1 mL of the autoclaved culture. The pure culture was serially diluted and the various dilutions were plated on the rich medium agar plate (composition given in table 1 above) and incubated at 28° C. for four days to measure colony forming units of T. elongata in the thawed culture vials. Two vials of the pure culture were used for genomic DNA extraction using MoBio POWERLYZER® POWERSOIL® DNA isolation kit. DNA extractions were carried-out according to the manufacturer's protocol in a sterile environment to avoid contamination during the extraction process. The 16S rRNA gene fragment of the isolated DNA was sequenced during the extraction process. The 16S rRNA gene fragment of the isolated DNA was sequenced using the Sanger sequencing method. Consensus sequences were constructed using the De Novo algorithm using the Genious 6.1.6 software (Biomatters LTD.).

Starting TSS was measured in all the assays using the protocol found in Standard Methods for the Examination of Water and Wastewater (APHA, AWWA, and WEF, 2005). Five mL sample was taken from each bottle and filtered through a 0.45 um filter at the beginning of the test. The bottles were then placed on a stir plate and sparged with a 70:30 (v:v) Nitrogen:CO₂ mixture and capped off using a rubber septum to create anaerobic environment in the bottles. The stir plate was then placed in an incubator at 27.5° C. The stirring mechanism was operated at 200 RPM for ensuring headspace-liquid partitioning of the gases present in the assay. After two hours of incubation, the anaerobic phase was ended by taking off the caps from the bottles allowing them to have aerobic environment. A five mL sample was drawn from each bottle at this time and filtered through a 1.2 μm syringe filter to assess conditions after the anaerobic incubation.

The bottles were then re-incubated without the septum to allow aerobic conditions. After four more hours of incubation, the bottles were taken out of the incubator and the final 5 mL samples were taken to assess the conditions after the test. A 5 mL sample was filtered using a 0.45 um syringe filter.

### Results:

Each assay was dosed with 1×10⁶ CFUs/mL of the T. elongata strain. The pure culture, non-bioaugmented, and bioaugmented assays were found to have 0.5±0.03, 3±0.33, and 2.7±0.07 gTSS/L respectively. Ortho-phosphorous, nitrate, and COD were measured for each bottle at each of the three sampling points. The concentration of phosphorous was measured as mg/L of reactive-P nitrate was measured as mg/L of N in NO₃ form (i.e. NO₃—N) and COD was measured in mg/L using Hach TNTplus™ high range kits and manufacturer's protocol. The data relating to average phosphorous at each sampling point can be seen below in Table 3.

TABLE 3
(Change in P over the 6 hour testing period).

| | 1 | 2 | 3 | 4 | 5 | Average | Stdev |
|---|---|---|---|---|---|---|---|
| | Time | | | | | | |
| PAO Pure | 23.8 | 23.6 | 24.1 | 24.1 | 25.1 | 24.14 | 0.577062 |
| Culture | | | | | | | |
| Non- | 25.4 | 24.5 | 26.7 | — | 25.5 | 25.525 | 0.903235 |
| Bioaugmented | | | | | | | |
| (autoclaved | | | | | | | |
| Control) | | | | | | | |
| Bioaugmented | 24.6 | 23.5 | 24 | 24.9 | 24.6 | 24.32 | 0.563028 |
| | Time 2 hrs | | | | | | |
| PAO Pure | 24.6 | 24.9 | 24.7 | 25.1 | 25.2 | 24.9 | 0.254951 |
| Culture | | | | | | | |
| Non- | 30 | 30.2 | 29.8 | 29.9 | 30.4 | 30.06 | 0.240832 |
| Bioaugmented | | | | | | | |
| (autoclaved | | | | | | | |
| Control) | | | | | | | |
| Bioaugmented | 29.3 | 29.3 | 29.8 | 28 | 29.7 | 29.22 | 0.719027 |
| | Time 6 hrs | | | | | | |
| PAO Pure | 20.8 | 20.7 | 21 | 21 | 21.1 | 20.92 | 0.164317 |
| Culture | | | | | | | |
| Non- | 25.6 | 23.9 | 24.3 | 25.4 | 24.5 | 24.74 | 0.730068 |
| Bioaugmented | | | | | | | |
| (autoclaved | | | | | | | |
| Control) | | | | | | | |
| Bioaugmented | 20.6 | 20.4 | 21.2 | 20.1 | 21.2 | 20.7 | 0.489898 |

| | Total P removed | | | | | | |
|---|---|---|---|---|---|---|---|
| | | | | | | Average | Stdev |
| PAO Pure | 3 | 2.9 | 3.1 | 3.1 | 4 | 3.22 | 0.443847 |
| Culture | | | | | | | |
| Non- | −0.2 | 0.6 | 2.4 | | 1 | 0.95 | 1.087811 |
| Bioaugmented | | | | | | | |
| (autoclaved | | | | | | | |
| Control) | | | | | | | |
| Bioaugmented | 4 | 3.1 | 2.8 | 4.8 | 3.4 | 3.62 | 0.794984 |

The data relating to average nitrate at each sampling point can be seen below in Table 4.

TABLE 4
(Change in nitrate over the 6 hour testing period).

| | 1 | 2 | 3 | 4 | 5 | Average | Stdev |
|---|---|---|---|---|---|---|---|
| | Time 0 | | | | | | |
| PAO Pure | 3.29 | 3.73 | 3.16 | 2.94 | 2.63 | 3.15 | 0.409451 |
| Culture | | | | | | | |
| Non- | 2.13 | 1.9 | 2.42 | — | 1.8 | 2.0625 | 0.275484 |
| Bioaugmented | | | | | | | |
| (autoclaved | | | | | | | |
| Control) | | | | | | | |
| Bioaugmented | 1.34 | 1.96 | 1.76 | 1.51 | 1.4 | 1.594 | 0.260154 |
| | Time 2 hrs | | | | | | |
| PAO Pure | 2.32 | 2.35 | 3.36 | 2.3 | 2.18 | 2.502 | 0.483963 |
| Culture | | | | | | | |
| Non- | 1.39 | 1.27 | 1.7 | 1.65 | 1.77 | 1.556 | 0.214895 |
| Bioaugmented | | | | | | | |
| (autoclaved | | | | | | | |
| Control) | | | | | | | |
| Bioaugmented | 1 | 1.11 | 1.08 | 1.07 | 1.25 | 1.102 | 0.092033 |
| | Time 6 hrs | | | | | | |
| PAO Pure | 2.32 | 2.22 | 2.54 | 3.09 | 2.57 | 2.548 | 0.336853 |
| Culture | | | | | | | |
| Non- | 1.37 | 1.6 | 1.66 | 1.63 | 1.5 | 1.552 | 0.118195 |
| Bioaugmented | | | | | | | |
| (autoclaved | | | | | | | |
| Control) | | | | | | | |
| Bioaugmented | 1.18 | 1.11 | 1.32 | 1.34 | 1.21 | 1.232 | 0.096799 |

The data relating to COD concentrations at each sampling point can be seen below in Table 5.

TABLE 5
(Change in COD over the 6 hour testing period).

| | 1 | 2 | 3 | 4 | 5 | Average | Stdev |
|---|---|---|---|---|---|---|---|
| | Time | | | | | | |
| PAO Pure | 5950 | 6680 | 7010 | 6960 | 7430 | 6806 | 548.4797 |
| Culture | | | | | | | |
| Non- | 4990 | 3530 | 6060 | — | 5460 | 5010 | 1079.475 |
| Bioaugmented | | | | | | | |
| (autoclaved | | | | | | | |
| Control) | | | | | | | |
| Bioaugmented | 6050 | 6060 | 6360 | 6260 | 6260 | 6198 | 136.8211 |
| | Time 2 hrs | | | | | | |
| PAO Pure | 6000 | 6480 | 6820 | 6720 | 7150 | 6634 | 428.3457 |
| Culture | | | | | | | |
| Non- | 5140 | 3410 | 5710 | 6260 | 5420 | 5188 | 1076.926 |
| Bioaugmented | | | | | | | |
| (autoclaved | | | | | | | |
| Control) | | | | | | | |
| Bioaugmented | 5780 | 5540 | 5860 | 5630 | 5740 | 5710 | 126.0952 |
| | Time 6 hrs | | | | | | |
| Pure Culture | 5710 | 6350 | 6720 | 7210 | 7040 | 6606 | 598.8572 |
| Non- | 4140 | 2670 | 5000 | 5320 | 4320 | 4290 | 1026.255 |
| Bioaugmented | | | | | | | |
| (autoclaved | | | | | | | |
| Control) | | | | | | | |
| Bioaugmented | 5090 | 5020 | 5070 | 5190 | 5870 | 5248 | 353.1572 |

### Example 2 (PAO Bioaugmentation Batch Study with Three Carbon Sources)

Example 2 was performed to test the strain LP2 Tetrasphaera elongata (DSM No.: 14184, Type strain) for its capability to remove polyphosphates in municipal wastewater when supplemented with one of three different carbon sources in batch assays.

### Materials and Methods:

The LP2 strain of T. elongata (DSM No.: 14184, Type strain) was grown in 1 L of a rich synthetic wastewater media (composition given in Table 6 below) over 72 hours at 28±1° C. in a 2 L baffled flask.

TABLE 6
Rich media composition used for growth of T. elongata.

| Chemical | Concentration, g/L |
|---|---|
| Peptone | 10 |
| Yeast Extract | 5 |
| Casamino Acids | 5 |
| Beef Extract | 2 |
| Malt Extract | 5 |
| Glycerol | 2 |
| MgSO₄—7H₂O | 1 |
| Tween 80 | 0.05 |
| Water | 1000 |

500 mL of this culture was autoclaved at 120° C. for 30 minutes. The autoclaved culture and the remaining 500 mL of live culture were then centrifuged separately at 8000 rpm, 15 min, at 4° C. The supernatant was discarded in a sterile environment and 400 mL of 0.22 μm filtered DI water was added to both of the centrifuged biomasses and shaken for 10 minutes to wash any remaining media out of the pellet. These were then centrifuged again at 8000 rpm, 15 min, at 4° C. The supernatant was again discarded in a sterile environment and 200 mL of 0.22 μm filtered DI water was added to each of the centrifuged biomasses and shaken for 10 minutes to make the final dilution to be added to the bottles.

Return activated sludge (RAS) was obtained from municipal wastewater treatment plant along with primary effluent. 1.1 L of RAS was added to 4.4 L of primary effluent, and then 700 mL of this mixture was distributed into twelve different serum bottles for each carbon source tested. Six serum bottles out of twelve were used as the bioaugmented assay set whereas the remaining six were used as the non-bioaugmented set. Sixty mL of the active T. elongata culture from the centrifuge bottles was added to six bioaugmented assays for each carbon source tested. 60 mL of the autoclaved (deactivated) culture was added to the other six beakers and these beakers were then used for initiating the non-bioaugmented control assays. Augmenting the non-bioaugmented control assays with deactivated culture ensured approximately equal amounts of carbon addition to the bioaugmented and the non-bioaugmented control assays for a fair comparison. Acetic acid, propionic acid, and molasses were each added to one bioaugmented serum bottle assay set (containing six replicates) and one non-bioaugmented beaker set (containing six replicates) at concentrations of 300 mg/L, 300 mg/L, and 400 mg/L respectively. 1.5 g/L of sodium bicarbonate was added to each bottle to buffer the pH to approximately 7.5. K₂HPO₄ was added to each bottle to achieve a 8.5 mg/L reactive-P concentration in the assays. Each assay had a final volume of 60 mL.

Starting TSS was measured in all the assays using the protocol found in Standard Methods for the Examination of Water and Wastewater (APHA, AWWA, and WEF, 2005). Five mL samples were taken from each bottle and filtered through a 1.2 μm filter at the beginning of the test to measure soluble reactive- and total-P and COD at the beginning of the test. To create an enhanced biological phosphorus removal (EBPR) environment, all the assays were then placed on a stir plate and sparged with a 70:30 (v:v) Nitrogen:CO₂ mixture and capped off using a rubber septum to create anaerobic environment in the bottles. The stir plate was then placed in an incubator at 27.5° C. After two hours of incubation, the anaerobic phase was ended by taking off the caps from the bottles allowing them to have aerobic environment. A five mL sample was drawn from each bottle at this time and filtered through a 1.2 μm syringe filter to assess conditions after the anaerobic incubation in terms of soluble reactive- and total-P and COD. The bottles were then re-incubated without the septum to allow aerobic conditions. After four more hours of incubation, the bottles were taken out of the incubator and the final 5 mL samples were taken to assess the conditions after the test. 5 mL samples were filtered using a 1.2 μm syringe filter. The pure culture was plated on a rich medium agar plate (composition given in table 1) and incubated at 28° C. for four days to measure colony forming units of T. elongata used for bioaugmenting the assay.

It was decided to use the same assays for running another EBPR cycle on the following day for confirming the results. The assays were maintained under aerobic conditions overnight for making sure that the assays don't have any easily degradable COD left in their biomass from the previous day. Only three assays from each set were run again on the following day using the same procedure as mentioned above. Again additional K₂HPO₄ and the three carbon sources were added to each bioaugmented and non-bioaugmented test assay as mentioned above on the second day for performing the test. Equal amounts of reactive-P concentration was ensured in all the assays by adding K₂HPO₄.

### Results:

On the first day, each assay was supplied with the active culture of T. elongata (DSM No.: 14184, Type strain) so that final concentration of the strain in the assay was 1×10⁹ CFUs/mL. The starting total suspended solids concentration (TSS) was found to be 3.0±0.1 g/L in all the assays. Reactive-phosphorous and COD were measured for each bottle at each of the three sampling points (before the start of the assay, end of the anaerobic phase and end of the aerobic incubation), while total phosphorus was measured at the beginning of the test and the end of the test only. The concentration of phosphorous was measured as mg/L of reactive-P and COD was measured in mg/L using Hach TNTplus™ kits as per manufacturer's protocol. The average reactive-phosphorous concentrations at each sampling point and the overall change in reactive-phosphorus over the first batch test can be seen Table 7 below. The reactive-phosphorus in the treated reactors was reduced to below 0.1 mg/L at the end of the first test whereas the untreated reactors showed much higher levels of reactive-P at the end of the test. The same data, for the second batch, can be seen in Table 8 and the results were very similar.

TABLE 7
Reactive-P Data for the EBPR cycle 1- Day 1 (Run1)

| | 1 | 2 | 3 | 4 | 5 | 6 | Average | Stdev |
|---|---|---|---|---|---|---|---|---|
| | Time 0 | | | | | | | |
| Acetic Acid + wastewater + MLSS + | 9.91 | 9.74 | 9.44 | | | | 9.70 | 0.24 |
| inactive T. elongata Control | | | | | | | | |
| Propionic Acid + wastewater + MLSS + | 8.48 | 8.61 | 10.1 | | | | 9.06 | 0.90 |
| inactive T. elongata Control | | | | | | | | |
| Molasses + wastewater + MLSS + | 9.97 | 9.86 | 10 | | | | 9.94 | 0.07 |
| inactive T. elongata Control | | | | | | | | |
| Acetic Acid + wastewater + MLSS + | 8.57 | 8.4 | 8.39 | | | | 8.45 | 0.10 |
| T. elongata | | | | | | | | |
| Propionic Acid + wastewater + MLSS + | 8.58 | 8.44 | 8.56 | | | | 8.53 | 0.08 |
| T. elongata | | | | | | | | |
| Molasses + wastewater + MLSS + | 8.46 | 8.14 | 8.54 | | | | 8.38 | 0.21 |
| T. elongata | | | | | | | | |
| | Time 2 hrs | | | | | | | |
| Acetic Acid + wastewater + MLSS + | 10.1 | 10.4 | 10.5 | 10.3 | 10.3 | 10.4 | 10.33 | 0.14 |
| inactive T. elongata Control | | | | | | | | |
| Propionic Acid + wastewater + MLSS + | 10.4 | 10.4 | 10.4 | 10.4 | 10.5 | 10.6 | 10.45 | 0.08 |
| inactive T. elongata Control | | | | | | | | |
| Molasses + wastewater + MLSS + | 10.3 | 10.4 | 10.6 | 10.5 | 10.7 | 10.5 | 10.50 | 0.14 |
| inactive T. elongata Control | | | | | | | | |
| Acetic Acid + wastewater + MLSS + | 6.68 | 7 | 6.88 | 7.16 | 6.81 | 7.43 | 6.99 | 0.27 |
| T. elongata | | | | | | | | |
| Propionic Acid + wastewater + MLSS + | 7.46 | 7.84 | 7.84 | 8 | 7.71 | 7.57 | 7.74 | 0.20 |
| T. elongata | | | | | | | | |
| Molasses + wastewater + MLSS + | 7.2 | 7.64 | 7.46 | 7.47 | 7.57 | 7.73 | 7.51 | 0.18 |
| T. elongata | | | | | | | | |
| | Time 6 hrs | | | | | | | |
| Acetic Acid + wastewater + MLSS + | 7.81 | 7.99 | 7.62 | 7.91 | 7.86 | 8.1 | 7.88 | 0.16 |
| inactive T. elongata Control | | | | | | | | |
| Propionic Acid + wastewater + MLSS + | 8.61 | 8.37 | 8.19 | 8.26 | 8.15 | 8.14 | 8.29 | 0.18 |
| inactive T. elongata Control | | | | | | | | |
| Molasses + wastewater + MLSS + | 7.47 | 7.85 | 8.37 | 9.37 | 7.98 | 7.85 | 8.15 | 0.66 |
| inactive T. elongata Control | | | | | | | | |
| Acetic Acid + wastewater + MLSS + | 0.029 | 0.03 | 0.019 | 0.038 | 0.028 | 0.032 | 0.03 | 0.01 |
| T. elongata | | | | | | | | |
| Propionic Acid + wastewater + MLSS + | 0.073 | 0.049 | 0.057 | 0.066 | 0.066 | 0.063 | 0.06 | 0.01 |
| T. elongata | | | | | | | | |
| Molasses + wastewater + MLSS + | 0.034 | 0.03 | 0.036 | 2.17 | 0.052 | 1.95 | 0.71 | 1.05 |
| T. elongata | | | | | | | | |
| | Reactive P Removed After 6 hr Incubation during the first EBPR cycle | | | | | | | |
| Acetic Acid + wastewater + MLSS + | 1.89 | 1.71 | 2.08 | 1.79 | 1.84 | 1.60 | 1.82 | 0.16 |
| inactive T. elongata Control | | | | | | | | |
| Propionic Acid + wastewater + MLSS + | 0.45 | 0.69 | 0.87 | 0.80 | 0.91 | 0.92 | 0.78 | 0.18 |
| inactive T. elongata Control | | | | | | | | |
| Molasses + wastewater + MLSS | 2.47 | 2.09 | 1.57 | 0.57 | 1.96 | 2.09 | 1.80 | 0.66 |
| Control | | | | | | | | |
| Acetic Acid + wastewater + MLSS + | 8.42 | 8.42 | 8.43 | 8.42 | 8.43 | 8.42 | 8.42 | 0.01 |
| T. elongata | | | | | | | | |
| Propionic Acid + wastewater + MLSS + | 8.45 | 8.48 | 8.47 | 8.46 | 8.46 | 8.46 | 8.46 | 0.01 |
| T. elongata | | | | | | | | |
| Molasses + wastewater + MLSS + | 8.35 | 8.35 | 8.34 | 6.21 | 8.33 | 6.43 | 7.67 | 1.05 |
| T. elongata | | | | | | | | |

TABLE 8
Reactive-P Data for the EBPR cycle 2 - Day 2 (Run2)

| | 1 | 2 | 3 | Average | Stdev |
|---|---|---|---|---|---|
| | Time 0 | | | | |
| Acetic Acid + wastewater + MLSS + | 8.32 | 8.36 | 8.11 | 8.26 | 0.13 |
| inactive T. elongata Control | | | | | |
| Propionic Acid + wastewater + MLSS + | 7.9 | 7.95 | 7.66 | 7.84 | 0.16 |
| inactive T. elongata Control | | | | | |
| Molasses + wastewater + MLSS + inactive | 8.17 | 7.85 | 8.02 | 8.01 | 0.16 |
| T. elongata Control | | | | | |
| Acetic Acid + wastewater + MLSS + T. elongata | 6.57 | 7.07 | 7 | 6.88 | 0.27 |
| Propionic Acid + wastewater + MLSS + T. elongata | 6.97 | 7.15 | 6.58 | 6.90 | 0.29 |
| Molasses + wastewater + MLSS + T. elongata | 7.4 | 7.54 | 7.82 | 7.59 | 0.21 |
| | Time 2 hrs | | | | |
| Acetic Acid + wastewater + MLSS + | 8.48 | 9.24 | 8.76 | 8.83 | 0.38 |
| inactive T. elongata Control | | | | | |
| Propionic Acid + wastewater + MLSS + | 8.39 | 8.52 | 8.58 | 8.50 | 0.10 |
| inactive T. elongata Control | | | | | |
| Molasses + wastewater + MLSS + inactive | 8.25 | 8.24 | 8.57 | 8.35 | 0.19 |
| T. elongata Control | | | | | |
| Acetic Acid + wastewater + MLSS + T. elongata | 5.19 | 5.32 | 5.6 | 5.37 | 0.21 |
| Propionic Acid + wastewater + MLSS + T. elongata | 5.55 | 5.55 | 5.69 | 5.60 | 0.08 |
| Molasses + wastewater + MLSS + T. elongata | 6.13 | 6.37 | 6.6 | 6.37 | 0.24 |
| | Time 6 hrs | | | | |
| Acetic Acid + wastewater + MLSS + | 6.56 | 7.6 | 7.26 | 7.14 | 0.53 |
| inactive T. elongata Control | | | | | |
| Propionic Acid + wastewater + MLSS + | 6.38 | 7.28 | 7.2 | 6.95 | 0.50 |
| inactive T. elongata Control | | | | | |
| Molasses + wastewater + MLSS + inactive | 6.34 | 6.94 | 7 | 6.76 | 0.36 |
| T. elongata Control | | | | | |
| Acetic Acid + wastewater + MLSS + T. elongata | 0.011 | 0.031 | 0.012 | 0.02 | 0.01 |
| Propionic Acid + wastewater + MLSS + T. elongata | 0.044 | 0.03 | 0.025 | 0.03 | 0.01 |
| Molasses + wastewater + MLSS + T. elongata | 0.211 | 0.073 | 0.052 | 0.11 | 0.09 |
| | Reactive P Removed After 6 hr | | | | |
| | Incubation during the first | | | | |
| | EBPR cycle | | | | |
| Acetic Acid + wastewater + MLSS + | 1.70 | 0.66 | 1.00 | 1.12 | 0.53 |
| inactive T. elongata Control | | | | | |
| Propionic Acid + wastewater + MLSS + | 1.46 | 0.56 | 0.64 | 0.88 | 0.50 |
| inactive T. elongata Control | | | | | |
| Molasses + wastewater + MLSS + inactive | 1.67 | 1.07 | 1.01 | 1.25 | 0.36 |
| T. elongata Control | | | | | |
| Acetic Acid + wastewater + MLSS + T. elongata | 6.87 | 6.85 | 6.87 | 6.86 | 0.01 |
| Propionic Acid + wastewater + MLSS + T. elongata | 6.86 | 6.87 | 6.88 | 6.87 | 0.01 |
| Molasses + wastewater + MLSS + T. elongata | 7.38 | 7.51 | 7.53 | 7.47 | 0.09 |

### Example 3: Use of T. elongata (DSM No.: 14184, Type Strain) for Phosphorus Removal in the Presence of Supernatant from Anaerobically Digested Municipal Sludge

A culture of the LP2 strain of T. elongata (DSM No.: 14184, Type strain) was dry formulated using wheat bran and stored at room temperature. The material was confirmed to have 1.33×10¹⁰ colony forming units of T. elongata per g of the material. This material was used for the current lab study. Five g of this culture material was suspended in 99 mL phosphate buffer in ‘Sterilized Pre-filled Dilution Bottles’ commercially manufactured by Weber DB™. After vigorous shaking for 60 sec, the particulate material was allowed to settle down for 5 min. Five mL supernatant from this settled mixture was used for augmenting pure culture and the bioaugmented assays. The supernatant was serially diluted and plated on standard methods agar plates (APHA, AWWA, and WEF, 2005). The plates were incubated at 28° C. to find the CFU counts of the T. elongata strain added to the assays.

Return activated sludge (RAS) and primary effluent wastewater was obtained from a municipal wastewater treatment plant. 0.25 L of RAS was added to 5 L of primary effluent to create mixed liquor. Anaerobically digested municipal sludge was collected from the same wastewater treatment plant and allowed to settle for 30 min and then the supernatant was carefully decanted by pouring it in a separate vessel while avoiding the settled material. This material was also used as another carbon source for the study whereas the settled material was discarded.

Starting total suspended solids (TSS) was measured in all the assays using the protocol found in Standard Methods for the Examination of Water and Wastewater (APHA, AWWA, and WEF, 2005). Assays mentioned in Table 9 were setup using 150 mL serum bottles. Two beginning samples were taken for each set of assay bottles before the contents were distributed among individual set of three assay serum bottles. For the two samples, five mL volume was filtered through a 1.2 μm syringe filter to assess the beginning reactive-P and COD conditions. The concentration of soluble phosphorous was measured as mg reactive-P/L and soluble COD was measured in mg/L using Hach TNTplus™ kits as per manufacturer's protocol for all the samples mentioned hereafter. A final volume of 50 mL was achieved in each assay. All the serum bottle assays were sparged with a 70:30 (v:v) Nitrogen:CO₂ mixture and capped off using a rubber septum to create an anaerobic environment. All the assays were then placed on a gyratory shaker table and the incubator was maintained at 27.5° C. and 200 rpm. After three hours of incubation, the anaerobic phase was ended by taking off the caps from the bottles and allowing them to have aerobic environment. A five mL sample was drawn from each bottle at this time and filtered through a 1.2 μm syringe filter to assess conditions after the anaerobic incubation in terms of soluble reactive-P and COD. The bottles were then re-incubated without the septum to allow aerobic conditions in all the assays. Again 5 mL samples were taken after 6 and 27 hrs of total incubation (3 hrs and 24 hrs of aerobic incubation respectively). The samples were filtered using a 1.2 μm syringe filter. For the samples collected after 6 hrs of incubation (3 hr aerobic incubation), both soluble reactive-P and COD were measured whereas for samples collected after 27 hrs of total incubation (24 hrs of aerobic incubation) only soluble reactive-P was measured.

TABLE 9
Assays setup for the test

| | | |
|---|---|---|
| Supernatant | Anaerobically digested | 20 mL Anaerobically digested |
| from the | municipal sludge | municipal sludge, 25 mL mixed |
| anaerobically | Bioaugmented assays - | liquor, 5 mL of T. elongata |
| digested | Three replicates | culture, K₂HPO₄ to give finally |
| municipal | | 1.4 to 3.5 mg reactive - P/L |
| sludge as a | Anaerobically digested | 20 mL Anaerobically digested |
| carbon source | municipal sludge Non- | municipal sludge, 25 mL |
| | Bioaugmented assays - | mixed liquor, 5 mL DI water, |
| | Three replicates | K₂HPO₄ to give finally 1.4 |
| | | to 3.5 mg reactive - P/L |
| | Anaerobically digested | 20 mL Anaerobically digested |
| | municipal sludge pure | municipal sludge, 5 mL of |
| | culture assays - Three | T. elongata culture, 25 mL DI |
| | replicates | water, K₂HPO₄ to give finally |
| | | 1.4 to 3.5 mg reactive - P/L |

### Results:

Each assay was dosed with the active culture of T. elongata so that final concentration of the strain in the assay was approximately 1×10⁷ CFUs/mL. Starting total suspended solids (TSS) in all the bioaugmented and non-bioaugmented assays was found to be less than 1 g/L. The average reactive-phosphorous concentrations at each sampling point the overall change in reactive-phosphorus over the first batch test can be seen in Table 10 below.

TABLE 10
Reactive phosphorus in the assays at various points

| | Mg Reactive - P/L | | |
|---|---|---|---|
| Beginning conditions | Sample 1 | Sample 2 | Average |
| Bioaugmented assay | 3.53 | 3.48 | 3.505 |
| Non-Bioaugmented assay | 1.43 | 1.38 | 1.405 |
| Pure culture assay | 2.46 | 2.5 | 2.48 |

| | Mg Reactive - P/L | | | | |
|---|---|---|---|---|---|
| | | | | | Standard |
| | Assay 1 | Assay 2 | Assay 3 | Average | deviation |
| Three hrs anaerobic | | | | | |
| incubation | | | | | |
| Bioaugmented assay | 4.5 | 4.27 | 4.79 | 4.52 | 0.26 |
| Non-Bioaugmented | 1.8 | 4.86 | 1.79 | 1.81 | 0.03 |
| assay | | | | | |
| Pure culture assay | 4.31 | 4.58 | 4.66 | 4.51 | 0.18 |
| Six hrs total (three hrs | | | | | |
| aerobic incubation) | | | | | |
| Bioaugmented assay | 1.91 | 2.11 | 2.04 | 2.02 | 0.10 |
| Non-Bioaugmented | 1.82 | 1.78 | 1.82 | 1.80 | 0.02 |
| assay | | | | | |
| Pure culture assay | 3.01 | 3.04 | 3.86 | 3.30 | 0.48 |
| Twenty seven hrs total | | | | | |
| (24 hrs aerobic | | | | | |
| incubation) | | | | | |
| Bioaugmented assay | 0.72 | 0.823 | 0.669 | 0.73 | 0.07 |
| Non-Bioaugmented | 0.627 | 0.617 | 0.418 | 0.55 | 0.11 |
| assay | | | | | |
| Pure culture assay | 1.39 | 1.29 | 1.5 | 1.39 | 0.10 |

The pure culture showed typical biological phosphorus removal activity in the presence of the studied carbon source. Bioaugmented assays showed greater phosphorus removal and hence higher biological phosphorus removal activity than the non-bioaugmented assays proving the effectiveness of the proposed approach.

### Example 4

The strain LP2 Tetrasphaera elongata (DSM No.: 14184, Type strain, also referred hereafter as SB3871) had poor shelf life, for example, after fermenting in a Gram negative growth medium and spray dried using wheat bran as a formulation material, the strain lost its viability within three months of 35° C., room temperature and 4° C. storage.

A stability study was done to see if freeze-drying with the addition of different lyoprotectants (compounds that protect a material during freeze-drying) would yield good stability.

### Materials and Methods:

Glycerol, maltodextrin, skim milk, and sucrose were selected as lyoprotectants. Four 2 L baffled glass flasks were prepared with 1 L of sterile Gram negative production medium and the strain SB3871 was inoculated in each flask from a single colony on a plate. The cultures were grown for 72 hours in an incubator at 28° C. and shaken at 200 rpm. The cultures were then centrifuged at 8000 rpm, 10 min, at 4° C. and concentrated approximately 10× to a 100 mL final volume. Sterile stock solution of 20% (w/v) glycerol (Fisherbrand catalog no. BP2291), 20% (w/v) maltodextrin DE value 20 (Maltrin M200® Grain Processing Corporation, USA), 10% (w/v) skim milk (Oxoid catalog no. LP0031), and 30% (w/v) sucrose (Sigma catalog no. S0389-1 KG) was prepared. The pH of the stock solutions was adjusted to 7.5 using a 1M NaOH solution.

The concentrated culture and the sterile lyoprotectant stock solutions were added together in 1:1 (V/V) proportion for each lyoprotectant. This mixture was then divided into three 50 mL conical tubes for freeze-drying. The tubes were frozen in a bath of dry ice and methanol and then placed in a −80° C. freezer overnight. The samples were then freeze-dried in a Labconco FreeZone 2.5 (catalog no. 7670521) freeze drier. The freeze drying cycle used a single cycle of 0.040 mBar chamber pressure and −54° C. condenser coil temperature for drying the samples. The freeze-drying process took seven days, except for the glycerol tubes which were kept in the freeze-dryer for fourteen days. Once dried, a sample was taken from each tube for bacterial quantification. The three tubes corresponding to each lyoprotectant were then placed in three different incubators maintained at 4, 22, and 35° C.

### Strain Quantification:

Strain SB3871's genome was sequenced and the output of that sequencing is shown in Table 11. The genome sequence was compared with the NCBI public database to identify the unique sections of the genome. High specificity qPCR primers and probes were developed for the unique regions as described previously (D'Imperio et al., 2013). Using these regions, multiple nucleotide sets were tested. Out of the several sets tested, the following set given in Table 12 was selected for quantification due to its high specificity.

TABLE 11
SB3871 sequencing output.

| | |
|---|---|
| Number of reads | 1,455,948 |
| Number of contigs | 171 |
| Number of scaffolds | 118 |
| Approx. genome size | 3.140 Mb |
| Read coverage | ~90x |
| GC content | 70% |

TABLE 12
Primers and probe selected
for the enumeration of SB3871.

| | | |
|---|---|---|
| F Primer | SB3871_c25_F | 5′-GGACGGCCTGC |
| | | TCAGTCAAC-3′ |
| | | (SEQ ID NO: 1) |
| R Primer | SB3871_c25_R | 5′-CGATTTGCGCA |
| | | CACTCGACG-3′ |
| | | (SEQ ID NO: 2) |
| Probe | SB3871_c25_P1 | 5′-[6-FAM]CTCC |
| | | TCCCCCGACTTCGA |
| | | CC[BHQ1a-Q]-3′ |
| | | (SEQ ID NO: 3) |

A standard dilution curve was developed for the strain and used for quantification through qPCR on a Roche LightCycler 480 II (catalog no. 05015278001) with the run parameters given in Table 13.

TABLE 13
Primers and probe selected for the enumeration of SB3871.

| | | | | Ramp Rate |
|---|---|---|---|---|
| Step | Cycles | Target (° C.) | Hold (hh:mm:ss) | (° C./s) |
| Pre-incubation | 1 | 95 | 00:05:00 | 4.4 |
| Amplification | 55 | 95 | 00:00:10 | 4.4 |
| Amplification | 55 | 60 | 00:00:30 | 2.2 |
| Cooling | 1 | 40 | 00:00:30 | 2.2 |

DNA was extracted using the propidium monoazide (PMA) method for quantification of live cells. The PMA method uses the DNA-intercalating dye propidium monoazide to distinguish viable cells from nonviable ones (Nocker et al., 2007). A 20 mM stock solution of PMA was prepared using 20% (V/V) dimethyl sulfoxide (DMSO).

For bacterial enumeration, 100 mg of each sample was placed in a 2 mL conical tube. One mL of molecular grade nucleic acid free water was added to the sample and the tube was vortexed for one minute. Five μL of the PMA stock solution was added to each tube. The tubes were wrapped in aluminum foil for five minutes and gently shaken by hand at one minute intervals. The aluminum foil was removed and the tubes were then placed on ice below a strong light source (stage light) for 4 minutes and rotated every minute. The tubes were then centrifuged at 5000×g for 5 minutes and the supernatant was decanted. DNA was then extracted using a MoBio PowerLyzer® PowerSoil® DNA Isolation Kit according to the manufacturer's protocol.

### Results:

Samples were taken for quantification every 15 days to test long term stability. The counts obtained through qPCR for all four lyoprotectants at each storage temperature are shown in Table 14 below.

TABLE 14
Live SB3871 counts for freeze-dried samples at each time point.

| | Time (days) | | | | | | | |
|---|---|---|---|---|---|---|---|---|
| Cryoprotectant/Temp (° C.) | −1 | 0 | 15 | 30 | 45 | 60 | 75 | 90 |
| 10% Skim Milk 4° C. | 7.92E+10 | 1.43E+10 | 1.92E+08 | 1.02E+10 | 1.84E+09 | 3.16E+09 | 4.61E+09 | 1.90E+09 |
| 30% Maltodextrin M | 1.42E+11 | 1.43E+10 | 7.28E+09 | 2.72E+10 | 8.8E+09 | 8.84E+09 | 6.41E+09 | 1.20E+10 |
| 200 4° C. | | | | | | | | |
| 30% Sucrose 4° C. | 6.83E+10 | 1.5E+10 | 2.84E+09 | 2.35E+10 | 3.13E+09 | 2.95E+09 | 1.32E+09 | 1.70E+09 |
| 20% Glycerol 4° C. | 3.79E+10 | 1.25E+10 | 7.97E+09 | 7.86E+09 | 1.23E+10 | 7.84E+09 | 7.51E+09 | 1.80E+10 |
| 10% Skim Milk 22° C. | 7.92E+10 | 1.43E+10 | 4.15E+09 | 1.42E+10 | 1.89E+09 | 1.80E+09 | 1.08E+10 | 1.10E+10 |
| 30% Maltodextrin M | 1.42E+11 | 1.43E+10 | 1.65E+10 | 1.03E+10 | 1.36E+10 | 2.41E+10 | 5.01E+10 | 1.18E+10 |
| 200 22° C. | | | | | | | | |
| 30% Sucrose 22° C. | 6.83E+10 | 1.5E+10 | 5.35E+09 | 3.51E+10 | 1.62E+09 | 9.61E+08 | 3.84E+08 | 1.27E+09 |
| 20% Glycerol 22° C. | 3.79E+10 | 1.25E+10 | 1.26E+10 | 2.3E+10 | 3.96E+09 | 2.61E+09 | 2.86E+09 | 2.74E+09 |
| 10% Skim Milk 35° C. | 7.92E+10 | 1.43E+10 | 2.53E+09 | 1.35E+10 | 4.6E+09 | 1.46E+09 | 2.99E+09 | 1.33E+10 |
| 30% Maltodextrin M | 1.42E+11 | 1.43E+10 | 8.83E+09 | 4.51E+10 | 9.35E+09 | 2.27E+10 | 2.43E+10 | 7.56E+10 |
| 200 35° C. | | | | | | | | |
| 30% Sucrose 35° C. | 6.83E+10 | 1.5E+10 | 2.19E+08 | 6.12E+08 | 4.15E+08 | 2.38E+08 | 7.92E+07 | 6.54E+07 |
| 20% Glycerol 35° C. | 3.79E+10 | 1.25E+10 | 3.17E+09 | 1.61E+10 | 1E+09 | 1.07E+09 | 3.22E+08 | 3.67E+08 |

The results of the study indicated that the freeze drying method with the given lyoprotectants performed excellent. Among the freeze-dried samples treated with different lyoprotectants, 20% Maltodextrin (Maltrin M200®) showed the best improved stability over the other treatments followed by the 10% non-fat dry milk treatment. As shown above, the sample formulated with maltodextrin indicated less than one log loss of activity during 90 days of storage at all the tested temperatures.

It will be understood that various modifications may be made to the embodiments disclosed herein. Therefore, the above description should not be construed as limiting, but merely as exemplifications of embodiments. Those skilled in art will envision other modifications within the scope and spirit of the claims appended hereto. Moreover, terms should not be interpreted as implying any particular order among or between various steps herein disclosed unless and except when the order of individual steps is explicitly described.

1-37. (canceled)

38. A process for treating wastewater to remove phosphorus, the process comprising:
contacting a wastewater process stream with one or more exogenous phosphorus accumulating organisms in combination with one or more carbon sources to form a mixed liquor, wherein the one or more exogenous phosphorus accumulating organisms uptake phosphorus from the mixed liquor, and
separating the one or more exogenous phosphorus accumulating organisms from the mixed liquor.

39. The process of claim 38, wherein the step of contacting comprises:
flowing the mixed liquor into one or more basins comprising bacteria operating under aerobic or anoxic conditions to initiate phosphorus uptake by the bacteria and/or one or more exogenous phosphorus accumulating organisms, and
wherein the step of separating comprises separating the bacteria from the mixed liquor.

40. The process of claim 39, wherein the one or more basins are aerated or anoxic.

41. The process of claim 38, wherein the one or more exogenous phosphorus accumulating organism is Tetrasphaera elongata.

42. The process of claim 38, wherein the one or more carbon sources are selected from the group consisting of acetic acid, propionic acid, glycerol, glucose, molasses, high fructose corn syrup, industrial carbonaceous waste, methanol and combinations thereof.

43. The process of claim 38, wherein the one or more carbon sources is obtained from recycled sludge.

44. The process of claim 38, wherein the wastewater process stream is underflow.

45. The process of claim 38, wherein the wastewater process stream is an anaerobic basin.

46. The process of claim 38, wherein the wastewater process stream is an aerobic or anoxic basin.

47. The process of claim 38, wherein phosphorus uptake occurs in an aerobic or anoxic basin.

48. The process of claim 38, wherein the one or more exogenous phosphorus accumulating organisms is added into the process stream in amount of at least one exogenous phosphorus accumulating organism is 1×10¹ to 1×10¹⁰ colony forming units per ml of process stream.

49. A process for treating wastewater to remove phosphorus, the process comprising:
contacting a wastewater process stream with one or more exogenous phosphorus accumulating organisms in combination with one or more carbon sources to form a mixed liquor;
flowing the mixed liquor into one or more aerated or anoxic basins comprising bacteria operating under aerobic or anoxic condition to initiate phosphorus uptake by the bacteria and one or more exogenous phosphorus accumulating organisms; and
separating the bacteria and one or more exogenous phosphorus accumulating organisms from the wastewater.

50. The process of claim 49, wherein the one or more exogenous phosphorus accumulating organism is Tetrasphaera elongata.

51. The process of claim 49, wherein the one or more carbon sources are selected from the group consisting of acetic acid, propionic acid, glycerol, glucose, molasses, high fructose corn syrup, and methanol.

52. The process of claim 49, wherein the one or more carbon sources is obtained from dewatered sludge recycle.

53. The process of claim 49, wherein the wastewater process stream is underflow or water separated from sludge.

54. The process of claim 49, wherein the wastewater process stream is the anaerobic basin.

55. The process of claim 49, wherein the wastewater process stream is the aerobic or anoxic basin.

56. The process of claim 49, wherein the phosphorus uptake occurs in an aerobic or anoxic basin.


SEQUENCE LISTING (3 sequences)

SEQ ID NO: 1 - DNA, 20 bp, Artificial sequence
  Synthetic construct
ggacggcctgctcagtcaac

SEQ ID NO: 2 - DNA, 20 bp, Artificial sequence
  Synthetic construct
cgatttgcgcacactcgacg

SEQ ID NO: 3 - DNA, 20 bp, Artificial sequence
  Synthetic construct
ctcctcccccgacttcgacc